(19) United States
(12) Patent Application Publication
(10) Pub. No.: US 2025/0350065 A1
(43) Pub. Date: Nov. 13, 2025

(54) CHASSIS CONNECTOR

(71) Applicant: Neutrik AG, Schaaan (LI)

(72) Inventor: Oliver DOBLER, Tschagguns (AT)

(73) Assignee: Neutrik AG, Schaan (LI)

(21) Appl. No.: 18/565,939

(22) PCT Filed: Jun. 2, 2022
(86) PCT No.: PCT/EP2022/065102

§ 371 Date: Nov. 30, 2023

(51) Int. Cl. H01R 13/625; H01R 13/52; H01R 13/74

(52) U.S. Cl. CPC H01R 13/625; H01R 13/5202; H01R 13/74

(57) ABSTRACT

A chassis connector is configured to precisely mate a mechanically lockable plug connection with a cable connector matched to the chassis connector as a counterpart, wherein signal transmission is enabled by the closed plug connection. According to a first aspect, the chassis connector is configured with a first part and a second part in at least two parts, both parts are provided for direct fastening to the mounting plate. According to a further aspect, taken on its own or in combination, the connector includes a cover, the cover and a flange provided for mounting on the mounting plate are designed to match each other such that a labyrinth seal and a contact seal are formed when the cover is closed. The labyrinth seal provides a first sealing stage with a throttling effect. The contact seal, including an elastomeric sealing component, provides a second sealing stage following the first sealing stage.

### CROSS REFERENCE TO RELATED APPLICATIONS

This application is a Section 371 National Phase of International Patent Application No. PCT/EP2022/065102, filed Jun. 2, 2022, the entire contents of which are incorporated by reference herein as if fully set forth.

### FIELD OF THE INVENTION

The present invention relates to a chassis connector, for precisely mating a mechanically lockable plug connection with a cable connector matched to the chassis connector as a counterpart (so that chassis connector and cable connector each mutually form a plug connection counterpart), wherein signal transmission is enabled by closed plug connection. In particular, the invention relates to a chassis connector for a plug-in device which may be plugged under load and voltage.

### BACKGROUND

Chassis connectors (also referred to as female XLR receptacles) are designed for installation in the housings of electrical equipment, in control panels or similar arrangements to provide signal transmission or electrical conduction between equipment or parts of equipment. The signal transmission or conductive connection is created by inserting a counterpart (complementary connector) complementary to the chassis connector into the chassis connector. By way of example, the complementary connector is designed as a cable connector for connecting an electrical cable to the chassis connection, typically with a mechanical interlock preventing unintentional disconnection of the connected cable and thus of the electrical connection. The signal transmission can, for example, be carried out electrically (e.g. via a copper cable connection) or optically (e.g. via a fiber optic connection).

Such chassis connectors are used, for example, in broadcast and measurement technology, e.g. for audio and video measurement technology such as is used in TV stations or for stage technology. Other areas of application relate to the lighting, network, PA, military, train transport and petrochemical sectors.

The plug connections are designed for heavy-duty applications or harsh environments. For example, they are specially designed to be resistant to environmental influences both when mated and unmated. Often, the phase, neutral and protective conductors are protected against accidental contact and the plugs are locked to prevent accidental disconnection. In addition, it is often required that the plug connection can be mated up to a specified current carrying capacity under load and voltage.

The connectors are available in two embodiments: on the one hand in a version for signal input, e.g. the input of mains voltage to a device; and on the other hand in a version for signal transmission, e.g. the transmission of mains voltage from one device to another. Unless otherwise indicated, the term “chassis connector” is used in the following to refer to both a chassis connector for signal input and a chassis connector for signal transmission.

Prior art chassis connectors, e.g. from the powerCON product family of Neutrik AG (Schaan, Liechtenstein), typically comprise a housing with an insertion opening for the complementary connector, wherein a projecting connecting flange protrudes from the insertion end of the housing, which has recesses for the passage of fastening means. On the insertion side, a flange with an insertion opening for the complementary connector and with mounting holes for connection to a device wall, a control panel or the like is also provided.

EP 3 514 892 B1 describes a typical plug connection between a chassis connector and a cable connector, wherein the plug connection is locked against inadvertent release of the cable connector and the chassis connector and the cable connector have mating key element counterparts or key elements so that the cable connector can be inserted into the chassis connector in only one specific rotational orientation.

The plug connections are often subjected to strong mechanical stresses during operation, which can, for example, cause increasing play when connecting the complementary counterpart into the chassis connector or can also lead to the breakage of connector parts.

For example, chassis plug connections typically have guides that cooperate with key elements of the cable connector matched thereto in such a way that the cable connector can be inserted into the chassis connector in only one specific rotational orientation specified by the key counterparts. Frequent loosening and re-mating of the plug connections, e.g. during touring stage performances, causes the guides to wear out, increasing, for example, the possibility of mismatching the chassis connector and the cable connector, or the possibility of loose contacts and a connection that leaks against environmental influences.

Furthermore, the high time pressure and the desired flexibility during stage performances often lead to a rough treatment of the equipment by the artists and the setup personnel. For example, it is quite common for set-up personnel to lean on or pull up on housings of cable connectors that have already been plugged in, in order to reach equipment that is located higher up, e.g. speaker boxes of a speaker tower that are located higher up.

In addition, the plug connections must withstand dust, water, and corrosive influences, which is why prior art chassis connectors feature a wide variety of sealing concepts to protect the chassis connector and the adjacent electronics from external influences both when plugged in and in the free state. Often, the complexity increases with the desired (higher) sealing class, wherein, for example, increasingly demanding manufacturing tolerances of the individual connector and sealing components become necessary. With increased complexity of the sealing assembly, the frequent connection and disconnection of chassis connectors and cable connectors in turn leads to wear and failure of the required sealing effect.

The basic design, in particular the external dimensions, of chassis connectors is identical worldwide and the chassis and cable connectors are so standardized in terms of compatibility between products from different manufacturers that economic pressure makes any deviation from this design virtually impossible. Accordingly, any adaptation of chassis connectors (as well as cable connectors) is subject to strict constraints in terms of geometric shape and space requirements. In particular, the scope in terms of bore and installation dimensions of the female receptacles is severely limited in order to ensure mechanical compatibility with device walls, control panels or the like manufactured according to known specifications. If, for example, the flange is too large or has an unusual shape, it is no longer possible to place a certain number of chassis connectors next to each other in a given space, as was the case in the prior art.

### SUMMARY

It is therefore an object of the invention to provide a chassis connector that overcomes disadvantages from the prior art, especially in light of the strict specifications with respect to the globally established installation dimensions.

Another object is to provide a chassis connector that has a reduced failure frequency, in particular due to mechanical stresses or due to environmental influences.

Another object is to provide a chassis connector that reduces the risk of misconnection between the chassis connector and the cable connector.

These objects are solved by the realization of at least a part of the characterizing features of the independent claims. Features which further form the invention in an alternative or advantageous manner are to be taken from one or more of the features disclosed herein.

The invention relates to various aspects of a chassis connector configured to precisely mate a mechanically lockable plug connection with a cable connector matched to the chassis connector as a counterpart and insertable into an opening of the chassis connector (such that the chassis connector and the cable connector each form a plug connection counterpart), wherein mating the plug connection between the chassis connector and the cable connector enables signal transmission. For example, mating the plug connection enables conduction of a signal for power supply or transmission of an audio signal.

In all aspects, the basic structure of the chassis connector is such that the chassis connector is adapted to be secured to a mounting plate and to be fixedly supported by the mounting plate when mounted to the mounting plate. In this case, the mounting plate has a mounting plate recess for the chassis connector and/or the cable connector, and the chassis connector is designed to be applied to and supported on an area of the mounting plate surrounding the mounting plate recess. The mounting plate has a front side directed towards where the cable connector can be brought to the chassis connector when mounted on the mounting plate, and an oppositely directed rear side.

According to a first aspect, the chassis connector comprises, in addition to said basic structure, a signal transmission contact element provided to contact a cable-connector-side signal transmission contact element counterpart by the mating of the plug connection, thereby providing signal transmission across the plug connection. The chassis connector further comprises a supporting skirt region configured to provide a support effect for the cable connector (in mated condition) with respect to loading forces (such as shear and/or shear loading of the cable connector) acting on the cable connector perpendicular to the cable connector insertion direction in the state generated by the mating of the plug connection.

The chassis connector is formed with a first and a second part in at least two parts, wherein both parts are provided for direct fastening to the mounting plate. For direct mounting on the mounting plate, the first part has a first-part flange to be applied to the rear side of the mounting plate and the second part has a second-part flange to be applied to the front side of the mounting plate. The first part further comprises the signal transmission contact element. The second part comprises the supporting skirt region, wherein supporting forces applied by the supporting skirt region and counteracting the loading forces—in the mounted state of the second part on the mounting plate by means of the provided direct fastening of the second part to the mounting plate—are at least partly carried by the mounting plate.

Due to the two-part shape and the arrangement of the signal transmission contact element in the first part, loading forces acting on the chassis connector transversely to the cable connector insertion direction can be at least partially decoupled from components of the chassis connector intended for electrical and mechanical connection to a cable connector, in that the main load of the loading forces can be borne by the second part arranged at the front side of the mounting plate. Thus, for example, forces acting on electrical and mechanical connection components of the chassis connector due to transverse loading on the plugged-in cable connector are reduced. The mechanical load capacity of the second part with respect to the loading forces, and thus of the entire chassis connector, is further increased by the direct attachment of the second part to the mounting plate, since the direct attachment can essentially provide a direct transmission of the loading forces to the mounting plate.

The two-part shape and the arrangement of the signal transmission contact element in the first part also enable improved utilization of the space requirement possible due to the fixed predetermined bore and installation dimensions.

In the prior art, the hole and mounting dimensions of chassis connectors for signal input differ in part from chassis connectors for signal forwarding (signal output). For example, power supply chassis connectors configured for signal output have larger hole and mounting dimensions than power supply chassis connectors configured for signal input, wherein the latter have hole and mounting dimensions corresponding to those of widely used other types of chassis connectors, e.g., chassis connectors for conducting audio signals. The difference between current signal output connectors and current signal input connectors (and other types of input and output connectors) is in itself unintentional and owed only to the lack of a solution for a more compact design of the signal output connector. Thus, due to the strict specifications regarding the globally established mounting dimensions, there is an interest in the prior art to match the power supply output connectors to the size of the other chassis connectors. A frequently used dimension for chassis connectors is the so-called D dimension, which provides for a flange with 26 mm (flange width) by 31 mm (flange length) edge lengths and a drill hole with a diameter between 23.6-24 mm.

Due to the two-part shape and the arrangement of the signal transmission contact element in the first part, for example, no load-bearing sheath connection is required between chassis connector components arranged on the front side of the mounting plate and chassis connector components arranged on the rear side of the mounting plate. To achieve the aforementioned decoupling of transverse forces (transverse to the cable connector insertion direction) acting on electrical and mechanical chassis connector components by absorbing the forces through the second part arranged on the front side of the mounting plate with the supporting skirt region, it is precisely advantageous if front and rear components of the chassis connector are not connected to each other in a load-bearing manner. Thus, the entire width of the drill hole can be used to pass through the cable connector. This allows the chassis connector to be designed for hole and mounting dimensions such as those used by widely used other types of chassis connectors. For example, a power supply output connector can thus be designed for mounting with hole and mounting dimensions of the more widely used power supply input connectors and audio connectors, e.g. in a design according to the so-called D dimension (26 mm×31 mm flange edge lengths, 23.6-24 mm hole diameter).

For example, no sheath element (outermost demarcation element, e.g. outermost wall, towards the mounting plate recess inner wall) is required which, when mounted on the mounting plate, projects into or through the mounting plate recess adjacent to the mounting plate inner wall in order to thereby demarcate an inner region of the connector (perpendicular to the insertion direction) from the sheath element (towards the insertion axis) against the inner wall of the mounting plate recess. The cross-section to be provided for the cable connector to enter the plug connection, i.e. the minimum mounting plate recess dimension, can only be limited by the cable connector.

In one embodiment, the first part comprises a mechanical retaining element which is provided to block a cable-connector-side retaining element counterpart with respect to an axial movement in the cable connector extraction direction within the scope of a first part of a locking mechanism which is actuatable by rotation of the cable connector in a screwing-in direction in a state of the cable connector being at least partially inserted into the chassis connector. Further, the second part comprises a mechanical locking element which is provided to cause engagement of a latch of the cable connector connected to the latch slider into the locking element in the context of a second part of the locking mechanism which is actuatable by displacement of a latch slider on the cable connector side. This allows the cable connector to be blocked with respect to rotation in the unscrewing direction which is directed opposite to the screwing-in direction.

For example, the retaining element is arranged and configured such that the retaining element counterpart engages behind the retaining element upon actuation of the first part of the locking mechanism.

In a further embodiment, the mechanical retaining element is formed as a groove assembly (e.g. an arrangement of rails or recesses). The grooves of the groove assembly first extend axially and thus serve in particular as key counterparts for key elements of the cable connector. Subsequently, the grooves extend normally to the axis or slightly obliquely to normal to the axis and serve in this region as a retaining component, wherein the retaining element counterpart is formed as a lug assembly which is inserted into the groove assembly by the insertion of the plug connection and is blocked against axial withdrawal by the groove assembly region extending normally or slightly obliquely to normal to the axis.

Alternatively, the mechanical retaining element is formed as a lug assembly and the retaining element counterpart as a groove assembly. The grooves of the groove assembly first extend axially—with reference to the orientation in the inserted state—and thus serve as key elements for the lug assembly serving in particular as key counterparts. Subsequently, the grooves extend normally to the axis or slightly obliquely to normal to the axis, wherein the groove assembly region extending normally or slightly obliquely to normal to the axis engages behind the lug assembly as a result of the insertion of the plug connection and thus the cable connector is blocked against axial extraction.

In a further embodiment, the retaining element is arranged and provided with an oblique path (obliquely viewed with respect to a plane perpendicular to the cable connector insertion direction) such that by and upon actuation of the first part of the locking mechanism, the retaining element counterpart is moved along the oblique path until the retaining element counterpart encounters a rotational stop. The stop is provided on the second part of the chassis connector and causes a final insertion position of the cable connector in the chassis connector to be reached (i.e., in which final mating position the cable connector is ultimately blocked with respect to further rotational movement in the screwing-in rotational direction and with respect to axial movement in the cable connector extraction direction).

In another embodiment, the second part has mechanical key counterparts provided to cooperate with key elements of the cable connector matched thereto such that the cable connector is insertable into the chassis connector in only one specific rotational orientation predetermined by the key counterparts.

In a further embodiment, the chassis connector has a cover for the opening, which cover is arranged in a fixed manner on the second-part flange, wherein the cover can be opened and closed by means of a pivot joint and has a sealing component in such a way that, in the closed state of the cover, the sealing component closes the opening in a sealing manner.

According to a further aspect, taken on its own or in combination with one of the other aspects, the chassis connector comprises, in addition to the basic structure described above, a mechanical retaining element provided to actuate, as part of a first part of a locking mechanism, which can be actuated by rotation of the cable connector in a screwing-in direction when the cable connector is at least partially inserted into the chassis connector, to block a retaining element counterpart on the cable connector side with respect to axial movement in the cable connector extraction direction. For example, the chassis connector is configured such that the mechanical retaining element forms part of a bayonet locking of the cable connector to the chassis connector. Furthermore, the chassis connector comprises a mechanical locking element which is provided to cause an engagement of a latch of the cable connector connected to the latch slider into the locking element within the scope of a second part of the locking mechanism which is actuatable by displacing a latch slider on the cable connector side and thus to block the cable connector with respect to a rotation in the unscrewing direction which is directed opposite to the screwing-in direction. The mechanical locking element is formed, for example, as a recess/latch socket for accommodating the latch of the cable connector so that, when the latch is received/engaged in a latching position, an unscrewing movement of a bayonet locking of the cable connector with the chassis connector is blocked. For example, the locking mechanism is designed as in EP 3 514 892 B1.

The chassis connector is formed with a first and a second part in at least two parts, wherein both parts are provided for direct fastening to the mounting plate. For direct fastening to the mounting plate, the first part has a first-part flange to be applied to the rear side of the mounting plate and the second part has a second-part flange to be applied to the front side of the mounting plate. The first part further comprises the mechanical retaining element and the second part comprises the mechanical locking element.

According to this aspect, another advantage of the two-part form is a flexibly designable installation depth of the chassis connector on the back of the mounting plate. As mentioned at the beginning, there is an interest in ensuring that further developments of chassis connectors are compatible with conventional cable connectors. Conventional cable connectors have actuable latches which, at a predetermined depth of penetration of the cable connector into conventional chassis connectors, engage in a recess/latch socket predetermined on the chassis connector side.

Due to the two-part design, the installation depth, i.e. the extension of the chassis connector on the rear side of the mounting plate perpendicular to the mounting plate, can be reduced compared to the prior art without any adjustments becoming necessary on the cable connector side and, for example, can be kept constant regardless of the thickness of the mounting plate. For example, the chassis connector can be configured as described at the outset in such a way that the cross-section required for the cable connector to enter the plug connection is restricted exclusively by the mounting plate recess (e.g. also thanks to a supporting skirt region as described at the outset). This allows a desired installation depth to be selected by the thickness (the extension perpendicular to the mounting plate) of the second part to be applied to the front side of the mounting plate. Since the cable connector fits substantially freely through the opening provided by the mounting plate recess (and is, for example, adequately supported by a supporting skirt region as described at the outset), the depth of penetration can be freely selected, wherein the thickness of the second part is such that operable latches of conventional cable connectors are arranged at the correct distance from the recess/latch socket of the second part and can thus engage in the recess/latch socket.

The two-part shape thus allows increased flexibility for adapting to different thicknesses of the mounting plate, especially if there is restricted space between the mounting plate and another device element on the back of the mounting plate. This is the case, for example, if the chassis connectors are to be connected (e.g. soldered) directly to a printed circuit board at the rear side of the mounting plate.

In one embodiment, the first part comprises a signal transmission contact element provided to contact a cable-connector-side signal transmission contact element counterpart by mating the plug connection, thereby providing signal transmission across the plug connection.

In a further embodiment, the second part comprises a supporting skirt region configured to provide a supporting action for the cable connector with respect to loading forces acting on the cable connector perpendicular to the cable connector insertion direction in the state generated by the mating of the plug connection, wherein supporting action forces applied by the supporting skirt region and counteracting the loading forces are at least partially carried by the mounting plate in the state of the second part mounted on the mounting plate by means of the provided direct fastening of the second part to the mounting plate.

In another embodiment, the second part has mechanical key counterparts provided to cooperate with key elements of the cable connector matched thereto such that the cable connector is insertable into the chassis connector in only one specific rotational orientation predetermined by the key counterparts.

In a further embodiment, the chassis connector has a cover for the opening, which cover is arranged in a fixed manner on the second-part flange, wherein the cover can be opened and closed by means of a pivot joint and has a sealing component in such a way that, in the closed state of the cover, the latter closes the opening in a sealing manner.

According to a further aspect, taken alone or in combination with any of the other aspects, the chassis connector comprises, in addition to the basic structure described above, a signal transmission contact element which is provided to contact a cable-connector-side signal transmission contact element counterpart by mating the plug connection and thereby provide signal transmission across the plug connection. The chassis connector further comprises mechanical key counterparts which are provided to cooperate with key elements of the cable connector matched thereto such that the cable connector is insertable into the chassis connector in only one specific rotational orientation predetermined by the key counterparts.

The key counterparts are designed, for example, as recesses or lugs which require a specific marked insertion orientation of the cable connector due to rotationally asymmetrical mutual arrangement and/or due to individually different geometry (e.g. mutually different shape or dimension). The key counterparts are formed, for example, as key recesses which, when the lugs of the cable plug connector are matched in shape and orientation thereto, permit insertion of the cable connector into the opening. Alternatively, the key counterparts are designed as lugs which allow the cable connector to be inserted into the opening when the key recesses of the cable connector are matched in shape and orientation.

For example, the key counterparts are designed as lugs of different widths, in which case the key elements on the cable connector side are designed as guide recesses/rails/grooves of different widths. Alternatively, the key counterparts are designed, for example, as guide recesses/rails/grooves of different widths, in which case the key elements on the cable connector side are designed as lugs of different widths.

The chassis connector is formed with a first and a second part in at least two parts, wherein both parts are provided for direct fastening to the mounting plate. For direct fastening to the mounting plate, the first part has a first-part flange to be applied to the rear side of the mounting plate and the second part has a second-part flange to be applied to the front side of the mounting plate. The first part further comprises the signal transmission contact element and the second part comprises the key counterparts.

The two-part shape and the arrangement of the key counterparts in the second part, which is intended for mounting on the front side of the mounting plate, can, for example, reduce the manufacturing tolerance for the key counterparts. This prevents the key counterparts from wearing out due to frequent loosening and mating of the chassis connector and cable connector.

In the prior art, chassis connectors are manufactured, for example, by means of injection molding. To optimize the release of the molded part used for the injection molding process from the injection molding material, the molded part has a so-called demolding slope, e.g. of 0.5° to 1°. This prevents, for example, adhesion during extraction of the molded part and thus destruction or warping of the injection mold produced. In the case of conventional chassis connectors, the injection molding process typically forces the molded part to be pulled out in the direction from which the cable connector can be brought up to the chassis connector (in the installed state, the extraction direction corresponds to a direction facing away from the front side of the mounting plate). This extraction direction of the molded part has the consequence that in the mounted state of the chassis connector on the mounting plate, the key counterparts have their greatest expansion towards the outside (away from the mounting plate), i.e. at the location of the first contact with the key elements of the cable connector matched to it, solely due to the manufacturing process. In order to ensure continuous insertion of the cable connector, the key counterparts are thus larger in the insertion area than necessary to accommodate the key elements of the cable connector. This promotes wear of the key counterparts of the chassis connector when the cable connector is frequently mated and unmated.

Thanks to the two-part mold, the first and second parts can be manufactured in separate injection molding processes, wherein the second part (which has the key counterparts and is intended for mounting on the front side of the mounting plate) can now be manufactured in such a way that the molded part to be used in the injection molding process can now be pulled off in a direction which, in the installed state, corresponds to a direction facing the mounting plate at the front side of the mounting plate. It is thus possible for the key counterparts of the chassis connector (of the second part of the chassis connector) to have their smallest dimension at the location of the first contact with the key elements of the cable connector matched thereto and to be matched exactly to the dimensions of the key elements of the cable connector. This precise matching reduces wear of the key counterparts due to frequent loosening and mating of the chassis connector and cable connector.

In one embodiment, the chassis connector has a cover for the opening, which cover is arranged fixedly on the second-part flange, wherein the cover can be opened and closed by means of a pivot joint and has a sealing component such that it closes the opening in a sealing manner in the closed state of the cover.

In a further embodiment, a sheath element of the chassis connector has a thickness of less than 0.35 mm perpendicular to the insertion direction. The sheath element (outermost wall of the chassis connector abutting the inside of the mounting plate recess) is provided to protrude into or through the mounting plate recess (abutting the mounting plate inner wall) in the state mounted with the first and second parts on the mounting plate in order to thereby delimit an inner region of the connector (perpendicular to the insertion direction) from the sheath element (towards the insertion axis) against the inner wall of the mounting plate recess.

In particular, in the state fastened to the mounting plate, the chassis connector is free of a sheath element sheathing the cable connector at the level of the mounting plate recess, such that the chassis connector is thereby configured such that the minimum mounting plate recess dimension is limited only by the cable connector.

In another embodiment, the first-part flange has blind holes provided for mounting on the mounting plate, wherein each of the blind holes is provided to receive a fastening means, such as a screw or pin, originating from the mounting plate for the purpose of fastening the first-part flange to the mounting plate.

In a further embodiment, the first-part flange and/or the second-part flange comprises a sealing element surrounding the opening, configured to create a sealing effect by pressing against the mounting plate when the chassis connector is applied to the mounting plate.

For example, the sealing element is formed in one piece with the first-part flange and the second-part flange, respectively, e.g. by producing the sealing element by means of two-component or multi-component injection molding.

According to a further aspect, taken on its own or in combination with one of the other aspects, the chassis connector comprises, in addition to the basic structure described above, a signal transmission contact element which is provided to contact a cable-connector-side signal transmission contact element counterpart by mating the plug connection and thereby provide signal transmission across the plug connection. The chassis connector further comprises mechanical locking mechanism elements, which are provided to bring about a locking cooperation of the locking mechanism elements with cable-connector-side locking mechanism counterpart elements within the scope of a locking mechanism by actuation of a cable-connector-side latch slider in such a way that the cable connector, which is inserted in the chassis connector in a locked state, is blocked with respect to rotation and axial movement in the cable connector extraction direction. For example, the locking mechanism elements form a bayonet lock for locking the cable connector in the chassis connector, wherein the chassis connector has a latch socket for receiving a latch of the cable connector, so that when the latch is received/latched in a latching position, an outward rotational movement of the bayonet lock of the cable connector is blocked with the chassis connector.

The chassis connector is further provided at least with one part or as a whole for direct fastening to the mounting plate, wherein the one part or the chassis connector as a whole has a flange for being applied to the front side of the mounting plate. The chassis connector has a cover for the opening which is arranged fixedly on the flange, wherein the cover is openable and closable by means of a pivot joint and has a sealing component in such a way that, in the closed state of the cover, the latter closes the opening in a sealing manner.

For example, the cover is designed as a spring-loaded sealing flap which closes automatically after the cable connector is unplugged, thus ensuring immediate protection against dust and water, e.g. in accordance with protection class IP65.

Covers known in the prior art are typically attached to the chassis connector as a further additional part. The pivot joint is spring-loaded so that the cover independently strives for a closed position, for which a spring is wound around a pivot axis of the pivot joint. Since the additional parts have not already been designed together with the flange, there is often little space available for the spring. As a result, the spring, which has relatively few coils, has a torque in the wide-open state that is perceived as too high by a user to hold the cover open comfortably (to insert or remove a cable connector, for example). The torque must have a minimum value for tight closing of the cover in the closed state, then increases abruptly due to the properties of the spring when the cover is opened.

By attaching the cover directly to the flange, the probability of improper attachment and the associated reduced sealing effect can be reduced. On the other hand, the cover and the flange can be manufactured to match each other in such a way that, for example, the space required for a spring provided for the cover closure is increased. As a result, a higher pressing torque can be achieved in the closed state, while at the same time a more uniform or weaker increase in the restoring torque can be achieved when the cover is opened.

In one embodiment, the sealing component is arranged and formed in such a way that, in the closed state of the cover, in addition to the opening, holes for fastening means and any fastening means inserted therein are also closed in a sealing manner, in particular so that the opening is then arranged together with the holes of the fastening means and any fastening means inserted therein in a common sealing chamber formed by the sealing component.

In a further embodiment, the pivot joint is spring-loaded so that the cover independently strives for a closed position, for which purpose a spring is wound around a pivot axis of the pivot joint and extends over two-thirds, in particular three-quarters, of the extension of the second-part flange in the direction of the pivot axis.

In a further embodiment, the opening can be sealed by means of a sealing assembly which enters the sealing state by closing the cover, comprising a sealing skirt and a sealing skirt counterpart. For example, the sealing skirt counterpart is arranged around the opening on the flange and the sealing skirt is arranged on the cover. Alternatively, the sealing skirt is arranged around the opening on the flange and the sealing skirt counterpart is arranged on the cover. Furthermore, the shape and dimensions of the sealing skirt are adapted to the sealing skirt counterpart in such a way that radial tension is produced by elastic deformation of the sealing skirt by slipping the sealing skirt over the sealing skirt counterpart over the entire circumference of the sealing skirt, wherein the sealing skirt and the sealing skirt counterpart each have a curved (or bent) profile over their entire circumference and are convex in shape.

In a further embodiment, the flange and cover are designed to match each other in such a way that, when the cover is in the closed state, a labyrinth seal is formed which provides a first sealing stage with a throttling effect. Furthermore, a contact seal with an elastomer sealing component provides a second sealing stage downstream of the first sealing stage, e.g. wherein the contact seal is provided by the sealing skirt described at the beginning and the sealing skirt counterpart described at the beginning.

According to a further aspect, taken on its own or in combination with one of the other aspects, the chassis connector comprises, in addition to the basic structure described above, a signal transmission contact element which is provided to contact a cable-connector-side signal transmission contact element counterpart by mating the plug connection and thereby provide signal transmission across the plug connection. The chassis connector further comprises mechanical locking mechanism elements, which are provided to bring about a locking cooperation of the locking mechanism elements with cable-connector-side locking mechanism counterpart elements within the scope of a locking mechanism by actuation of a cable-connector-side latch slider in such a way that the cable connector, which is inserted in the chassis connector in a locked state, is blocked with respect to rotation and axial movement in the cable connector extraction direction. The chassis connector has a flange to be applied to the mounting plate and holes for fastening means for direct fastening of the chassis connector to the mounting plate (by fastening means to be inserted into the fastening means holes).

The chassis connector further comprises a cover for the opening, wherein the cover can be opened and closed by means of a pivot joint. The opening and the holes for fastening means, as well as any fastening means inserted therein, can be sealed by means of a sealing assembly which enters the sealing state by closing the cover, comprising a sealing skirt and a sealing skirt counterpart. Furthermore, the shape and dimensions of the sealing skirt are matched to the sealing skirt counterpart in such a way that radial tension is produced by elastic deformation of the sealing skirt over the sealing skirt counterpart over the entire circumference of the sealing skirt, wherein the sealing skirt and the sealing skirt counterpart each have a curved (or bent) profile over their entire circumference and are convex in shape.

In one embodiment, the sealing skirt counterpart is arranged around the opening on the flange and the sealing skirt is arranged on the cover. Alternatively, the sealing skirt is arranged around the opening on the flange and the sealing skirt counterpart is arranged on the cover.

In a further embodiment, the locking mechanism elements comprise a mechanical retaining element which is provided for blocking a cable-connector-side retaining element counterpart with respect to an axial movement in cable connector extraction direction in the context of a first part of the locking mechanism which is actuatable by rotation of the cable connector in a screwing-in direction in a state of the cable connector being at least partially inserted into the chassis connector. Furthermore, the locking mechanism elements comprise a mechanical locking element which is provided to cause an engagement of a latch of the cable connector connected to the latch slider into the locking element in the context of a second part of the locking mechanism which is actuatable by displacement of a latch slider on the cable connector side and thus to block the cable connector with respect to a rotation in the unscrewing direction which is directed opposite to the screwing-in direction.

In a further embodiment, the sealing skirt counterpart or the sealing skirt encloses holes provided for mounting on the mounting plate by means of piercing fastening means (e.g. screws or pins). The holes are thus arranged within the circumference of the sealing skirt counterpart or the sealing skirt.

In a further embodiment, the flange and cover are designed to match each other in such a way that, in the closed state of the cover, a labyrinth seal is formed which provides a first sealing stage with a throttling effect. Furthermore, a second sealing stage downstream of the first sealing stage is provided by slipping the sealing skirt over the sealing skirt counterpart.

According to a further aspect, taken on its own or in combination with one of the other aspects, the chassis connector comprises, in addition to the basic structure described above, a signal transmission contact element which is provided to contact a cable-connector-side signal transmission contact element counterpart by mating the plug connection and thereby provide signal transmission across the plug connection. The chassis connector further comprises mechanical locking mechanism elements, which are provided to bring about a locking cooperation of the locking mechanism elements with cable-connector-side locking mechanism counterpart elements within the scope of a locking mechanism by actuation of a cable-connector-side latch slider in such a way, that the cable connector, which is inserted in the chassis connector in a locked state, is blocked with respect to rotation and axial movement in the cable connector extraction direction. The chassis connector is provided for direct fastening to the mounting plate and has a flange for this purpose to be applied to the mounting plate.

The chassis connector has a cover for the opening, wherein the cover can be opened and closed by means of a pivot joint. The opening can be closed in a sealing manner by means of a sealing assembly which enters the sealing state when the cover is closed, for which purpose the flange and cover are designed to match one another in such a way that a labyrinth seal is formed which provides a first sealing stage with a throttling effect. Furthermore, a contact seal is provided with an elastomeric sealing skirt and a sealing skirt counterpart, wherein the shape and dimensions of the sealing skirt are matched to the sealing skirt counterpart in such a way that, when the sealing skirt is slipped over the sealing skirt counterpart, tension of the sealing skirt on the sealing skirt counterpart is produced by elastic deformation of the sealing skirt.

In one embodiment, the cover and the flange are matched to each other in such a way that, in the closed state of the cover, a cover element arranged around the opening, e.g. an edge element of the cover, rests on a cover element bearing surface of the flange. The flange has an elevation on the inside of the cover element bearing surface (towards the opening) which extends axially in the extraction direction of the cable connector, so that when the cover element rests on the cover element bearing surface, the elevation projects into the cover and thus provides part of the labyrinth seal.

For example, the flange has a plurality of step-like elevations rising toward the opening and the cover has matching cover elements provided for placement on the step-like elevations which—in the closed state of the cover—extend axially in different steps (smaller extension toward the axis). When the cover is closed, the differently extending cover elements lie in a fitting manner on the step-like elevations and thus provide a plurality of labyrinth elements of the labyrinth seal.

In a further embodiment, the sealing skirt counterpart is formed as a further elevation arranged on the inside of the elevation and extending axially (in the extraction direction of the cable connector), which is intended to be slipped over by the sealing skirt when the cover is closed.

In a further embodiment, the cover is formed in such a way that—in the open state of the cover and in the plugged-in state of the cable connector as a result of the mating of the plug connection—an element of the cover, which is designed to be hard in comparison with the sealing skirt (not as an elastomer), abuts the cable connector. For example, the element of the cover is a cover element provided for providing the labyrinth seal (e.g. edge element of the cover), in particular that the cover then abuts the cable connector at a location of a cover-side component of the labyrinth seal.

In an exemplary concrete embodiment of a power supply chassis connector, the invention relates to a chassis connector for precisely mating a mechanically lockable plug connection with a cable connector matched to the chassis connector as a counterpart and insertable into an opening of the chassis connector. Mating of the plug connection between the chassis connector and the cable connector enables a current supply signal to be conducted in the direction from the chassis connector to the cable connector. The chassis connector is provided to be fixed to a mounting plate and to be fixedly supported by the mounting plate when mounted to the mounting plate.

The mounting plate has a mounting plate recess for the chassis connector and/or the cable connector and the chassis connector is designed to be applied to and supported on an area of the mounting plate surrounding the mounting plate recess. The mounting plate has a front side directed towards where the cable connector can be brought to the chassis connector when mounted on the mounting plate, and an oppositely directed rear side.

The chassis connector includes a signal line contact element provided to contact a cable-connector-side signal line contact element counterpart upon mating of the plug connection, thereby providing current supply signal transmission across the plug connection. Further, the chassis connector includes a supporting skirt region configured to provide a supporting action for the cable connector with respect to loading forces acting on the cable connector perpendicular to the cable connector insertion direction in the state generated by the mating of the plug connection. In addition, a mechanical locking element designed as a latch lock is provided in order, within the framework of a locking mechanism which—in the axially inserted state of the cable connector in the chassis connector—can be actuated by displacing a latch slider on the cable connector side to effect an engagement of a latch of the cable connector connected to the latch slider in the closing element (and thus to block the cable connector with respect to a rotation in the unscrewing direction, which is directed opposite to the screwing-in direction).

The chassis connector is formed with a first and a second part in at least two parts, with both parts being provided for direct fastening to the mounting plate. For this purpose, the first part has a first-part flange for being applied to the rear side of the mounting plate and the second part has a second-part flange for being applied to the front side of the mounting plate. The first part further comprises the signal transmission contact element and the second part comprises the supporting skirt region, wherein support forces applied by the supporting skirt region and counteracting the loading forces in the mounted state of the second part on the mounting plate are at least partially carried by the mounting plate by means of the provided direct attachment of the second part to the mounting plate. The second part further comprises the mechanical locking element.

When attached to the mounting plate, the chassis connector is free of a sheath element encasing the cable connector at the level of the mounting plate recess, such that the chassis connector is thus configured that the minimum mounting plate recess dimension is limited only by the cable connector.

In one embodiment, the first-part flange has blind holes provided for mounting on the mounting plate, wherein each of the blind holes is provided to receive a fastening means, such as a screw or pin, originating from the mounting plate for the purpose of securing the first-part flange to the mounting plate.

In a further embodiment, the first-part flange and/or the second-part flange comprises a sealing element surrounding the opening, configured to create a sealing effect by pressing against the mounting plate when the chassis connector is applied to the mounting plate.

For example, the sealing element is produced by means of two-component or multi-component injection molding and is formed in one piece with the first-part flange and the second-part flange, respectively.

With reference to the embodiments based on the aspect described at the beginning that the chassis connector is formed at least in two parts and comprises a first and a second part, which are provided for direct fastening to the mounting plate, the second part for example, which is provided for mounting on the front side of the mounting plate, may be made of metal. The first part, which is provided for mounting on the rear side of the mounting plate, preferably has insulating material or is made of insulating material in particular.

For example, the design of the second part made of metal has the advantage that it wears out less quickly (e.g., compared to softer, especially electrically insulating material such as plastic) and that the second part is therefore suitable for particularly demanding environments. For example, such second parts made of metal could be used with equipment that is to be rented out and therefore frequently assembled and disassembled (and possibly handled with less care). For example, the use of metal further reduces wear of the key element counterparts (or generally those areas/elements of the chassis connector which form the insertion opening for the cable connector) arranged on the second part, caused by frequent loosening and mating of the chassis connector and cable connector.

Furthermore, the invention relates to chassis connectors of the embodiments described at the beginning, where, however, all aspects related to the two-part shape are implemented in further embodiments in such a way that the second part is in each case an integral part of the mounting plate. Again, in one embodiment, the second part is made of metal, for example to reduce wear.

The aspects described at the beginning with regard to the cover and the labyrinth and contact seals (provided by cover elements) can be implemented separately from the two-part form of the chassis connector.

### BRIEF DESCRIPTION OF THE DRAWINGS

The chassis connector according to the invention is described in more detail below by way of purely exemplary embodiments shown schematically in the figures. Identical elements are marked with the same reference signs in the figures. The embodiments described are generally not shown to scale and they are also not to be understood as a limitation, wherein the figures show in detail:

FIGS. 1A-1D: show various views of an exemplary embodiment of a current signal output chassis connector according to the invention which is mounted on a mounting plate;

FIGS. 2A-2C: show various views of the first and second parts of the current signal output chassis connector shown in FIGS. 1A-1D;

FIGS. 3A-3D: show various views of an exemplary embodiment of a current signal input chassis connector according to the invention which is mounted on a mounting plate;

FIGS. 4A-4C: show different views of the first and second parts of the current signal input chassis connector shown in FIGS. 3A-3D;

FIGS. 5A-5B: show perspective views into the openings of the current signal output chassis connector shown in FIGS. 1A-1D and the current signal input chassis connector shown in FIGS. 3A-3D;

FIGS. 6A-6C: show various views of the current signal output chassis connector shown in FIGS. 1A-1D and the current signal input chassis connector shown in FIGS. 3A-3D, which are mounted side by side on a mounting plate;

FIGS. 7A-7B: show various views of the first and second parts of the current signal output chassis connector shown in FIGS. 1A-1D and the current signal input chassis connector shown in FIGS. 3A-3D, which are intended to be mounted on a mounting plate;

FIG. 8: shows a further view of the first and second parts of the current signal output chassis connector shown in FIGS. 1A-1D and the current signal input chassis connector shown in FIGS. 3A-3D, which are intended to be mounted on a mounting plate;

FIG. 9: shows a sectional view of the current signal output chassis connector shown in FIGS. 1A-1D and the current signal input chassis connector shown in FIGS. 3A-3D, which are mounted side by side on a mounting plate;

FIG. 10: shows a further sectional view of the current signal output chassis connector shown in FIGS. 1A-1D which is mounted on a mounting plate;

FIGS. 11A-11D: show various views of another exemplary embodiment of a current signal output chassis connector according to the invention which is mounted on a mounting plate;

FIGS. 12A-12D: show various views of another exemplary embodiment of a current signal input connector according to the invention which is mounted on a mounting plate;

FIGS. 13A-13C: show various views of the current signal output chassis connector shown in FIGS. 11A-11D and the current signal input chassis connector shown in FIGS. 12A-12D, which are mounted side by side on a mounting plate;

FIGS. 14A-14B: show various views of the first and second parts of the current signal output chassis connector shown in FIGS. 11A-11D and the current signal input chassis connector shown in FIGS. 12A-12D, which are intended to be mounted on a mounting plate;

FIG. 15: shows a further view of the first and second parts of the current signal output chassis connector shown in FIGS. 11A-11D and the current signal input chassis connector shown in FIGS. 12A-12D, which are intended to be mounted on a mounting plate;

FIG. 16: shows a sectional view of the current signal output chassis connector shown in FIGS. 11A-11D and the current signal input chassis connector shown in FIGS. 12A-12D, which are mounted side by side on a mounting plate;

FIG. 17: shows a further sectional view of the current signal output chassis connector shown in FIGS. 11A-11D and the current signal input chassis connector shown in FIGS. 12A-12D, which are mounted side by side on a mounting plate;

FIGS. 18A-18B: show various views of the current signal output chassis connector shown in FIGS. 1A-1D (with cable connector counterpart inserted) and the current signal input chassis connector shown in FIGS. 3A-3D (without cable connector counterpart) compared with prior art;

FIGS. 19A-19B: show various views of the current signal output chassis connector shown in FIGS. 1A-1D (with cable connector counterpart inserted) and the current signal input chassis connector shown in FIGS. 3A-3D (without cable connector counterpart) compared with the prior art, wherein another prior art current signal output chassis connector (to be attached from the back of the mounting plate) is shown in comparison with FIGS. 18A-18B;

FIGS. 20A-20B: show further views of the chassis connector and cable connector assembly shown in FIGS. 19A-19B;

FIG. 21: shows a perspective view of the current signal output chassis connector shown in FIGS. 11A-11D (with cable connector counterpart inserted) and the current signal input chassis connector shown in FIGS. 12A-12D (without cable connector counterpart) compared with prior art;

FIGS. 22A-21E: show various views of a prior art current signal input cable connector;

FIG. 23: shows a perspective view of the current signal input cable connector of FIGS. 21A-21E;

FIGS. 24A-24C: show various views of the current signal output chassis connector shown in FIGS. 1A-1D with cable connector counterpart inserted;

FIGS. 25A-25C: show various views of a latch slider of a prior art current signal input cable connector;

FIGS. 26A-26E: show various views of a prior art current signal output cable connector;

FIG. 27: shows a perspective view of the current signal output cable connector of FIGS. 26A-26E;

FIGS. 28A-28B: show different views of a plug connection between a chassis connector according to FIGS. 11A-11D and a cable connector, wherein the cover presses against the cable connector;

FIGS. 29A-29D: show various views of an exemplary embodiment of a second-part flange according to the invention, which has a cover for the opening arranged fixedly on the second-part flange;

FIG. 30: shows a sectional view of the second-part flange shown in FIGS. 29A-29D, with the cover closed;

FIG. 31: shows a perspective view of the second-part flange shown in FIGS. 29A-29D, with the cover not fully closed.

### DETAILED DESCIPTION OF THE PREFERRED EMBODIMENTS

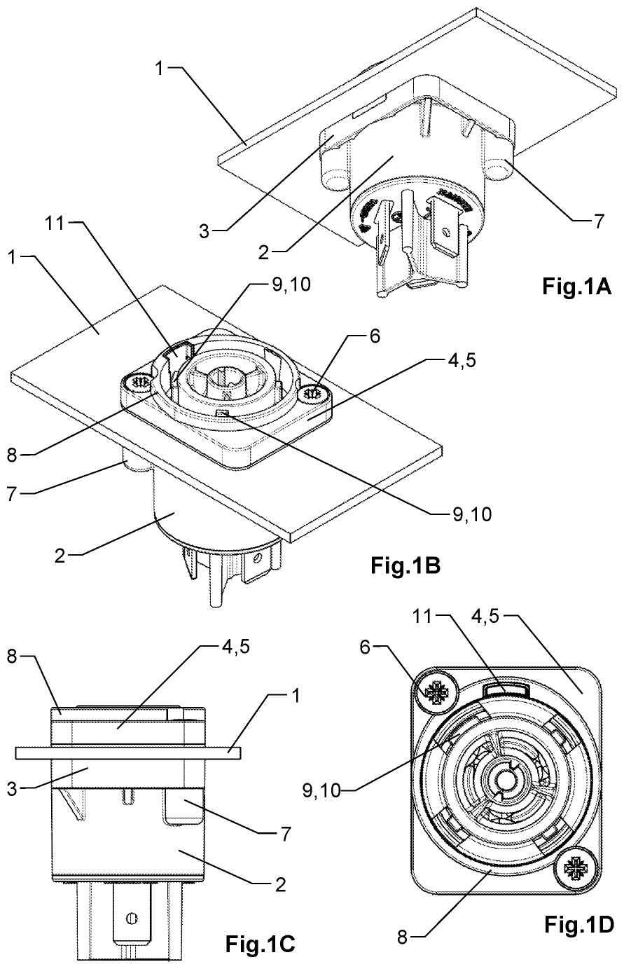

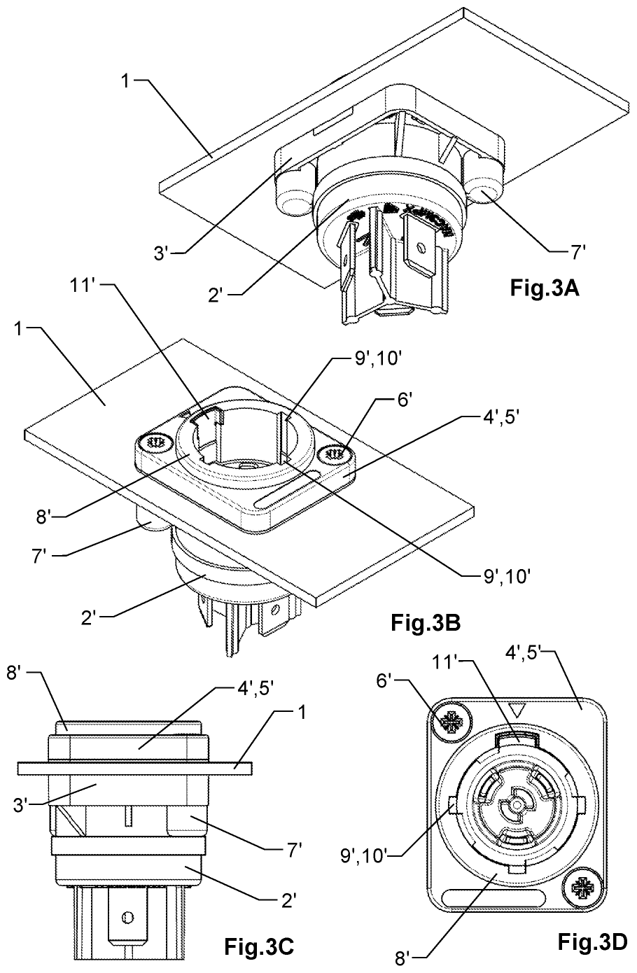

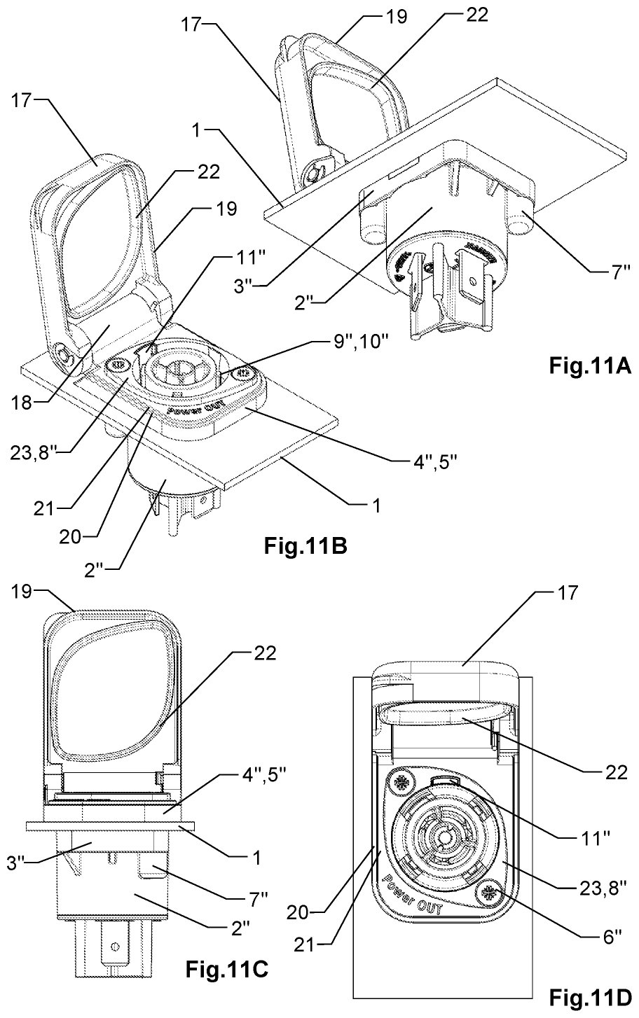

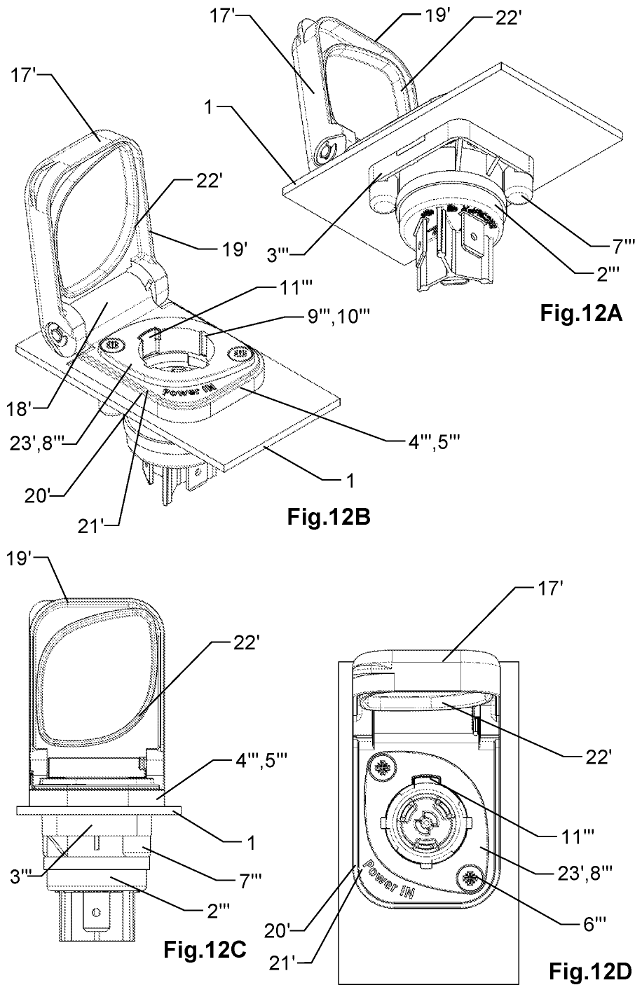

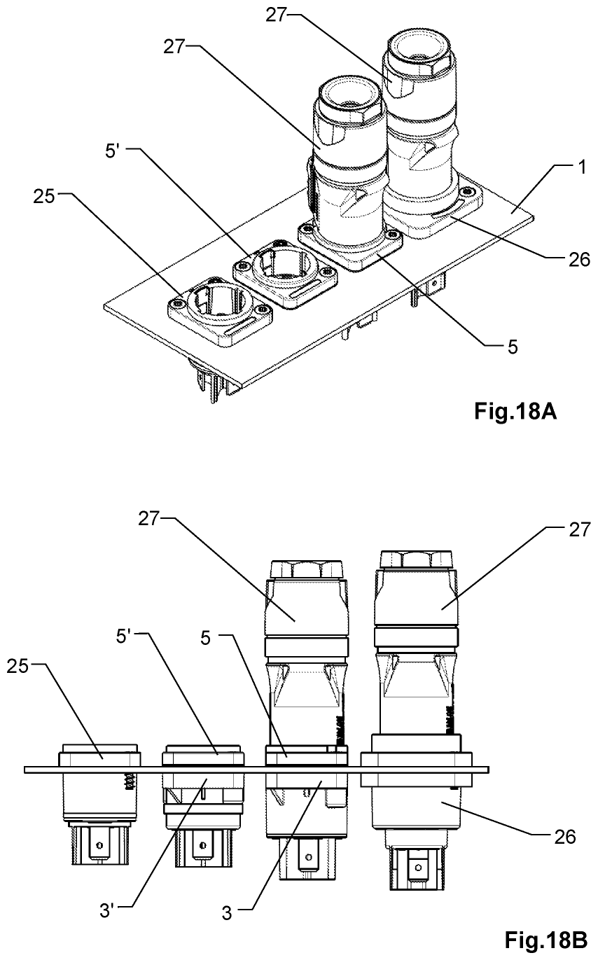

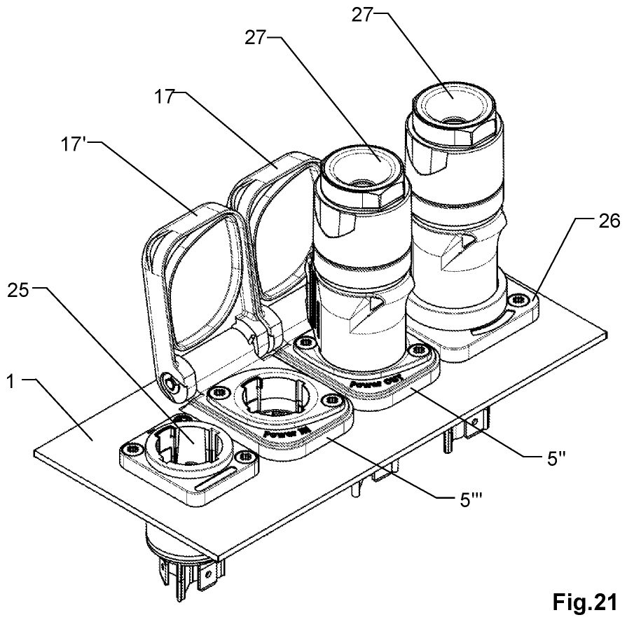

The inventive aspects are exemplified by two different embodiments of a current signal output chassis connector (FIGS. 1A-1D, FIGS. 11A-11D) and a current signal input chassis connector (FIGS. 3A-3D, FIGS. 12A-12D) provided for power supply. In particular, compared to known power supply connectors, the inventive chassis connector has the advantage of enabling a design of the current output chassis connector for hole and mounting dimensions used by widely used other types of chassis connectors. For example, the chassis connector is designed according to the so-called D dimension (see FIGS. 18A-18B, FIG. 21).

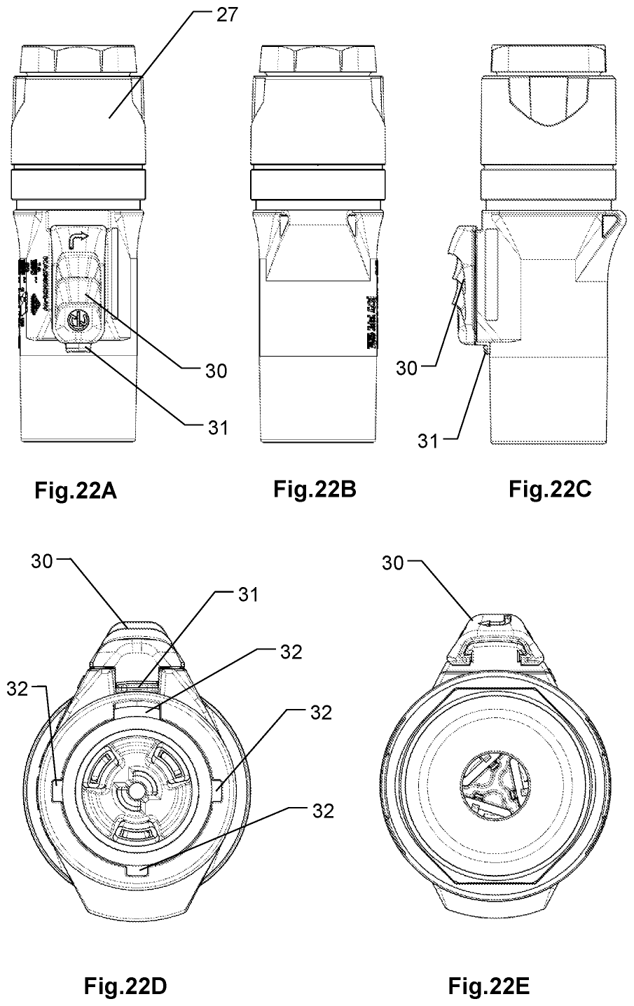

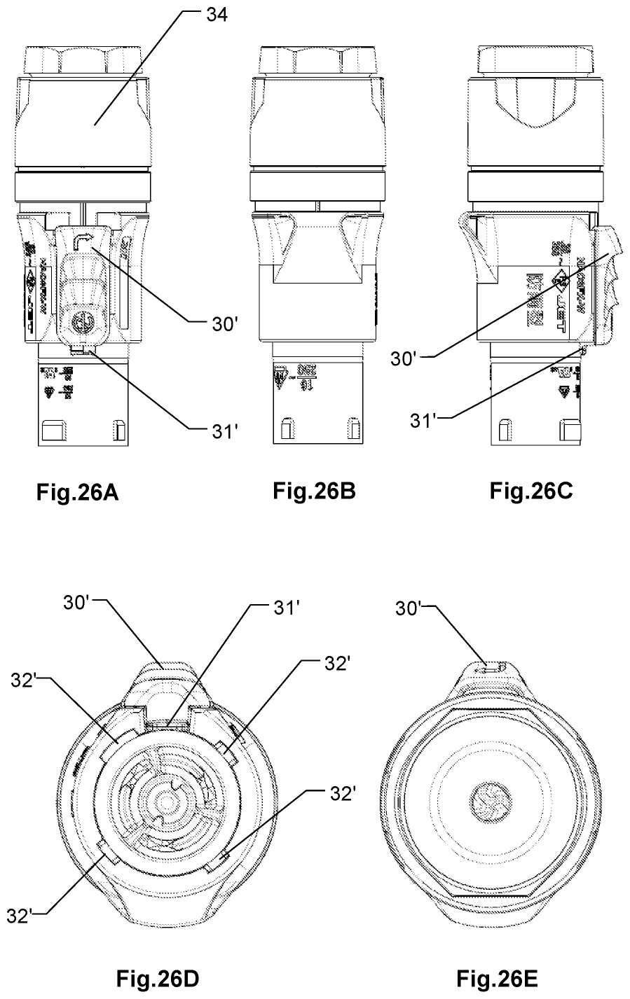

Due to the large numbers of cable connectors and chassis connectors in circulation worldwide, there is an economic interest in ensuring that further developments of chassis connectors are compatible with conventional cable connectors (see FIG. 22A-22E and FIG. 26A-26E) intended as counterparts. In addition to the electrical or optical signal transmission compatibility, there are clearly specified mechanical boundary conditions to be fulfilled.

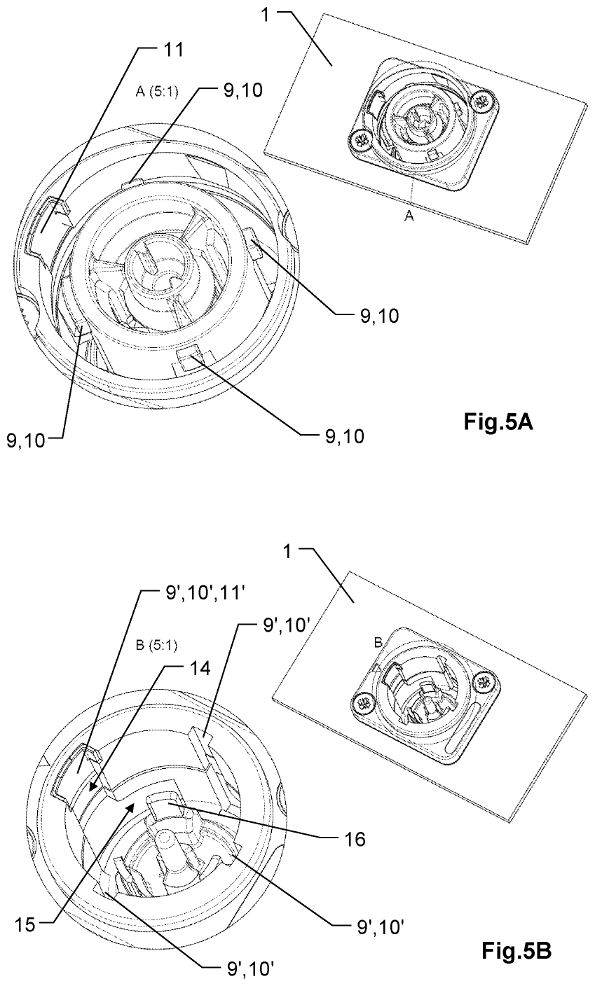

For example, conventional chassis connectors are configured for so-called bayonet locking, for which purpose they have guides which interact with key elements and guide counterparts of the cable connector matched thereto in such a way that the cable connector can be inserted into the chassis connector in only one specific rotational orientation predetermined by the key elements and can be inserted axially deeper into the opening by means of rotational movement about the insertion axis (see, for example, FIGS. 5A-5B, for example, which show inventive chassis connectors with grooves or lugs designed as key counterparts). At a predetermined penetration depth, a blocking position is reached, wherein a retaining element counterpart on the cable connector side engages behind a retaining element of the chassis connector, so that the cable connector is blocked with respect to an axial movement in the cable connector extraction direction. Furthermore, turning back of the cable connector is prevented by means of a latch of the cable connector engaging in a latch socket of the chassis connector. The dimensions and positioning of the key elements, guide counterparts, retaining element counterparts and latches of the cable connectors must continue to be compatible with further developed chassis connectors.

Chassis connectors according to the present invention can be configured for different applications, for example for the signal transmission of a signal for power supply or for a transmission of an audio signal. Depending on the application, cable connectors (e.g. from the prior art) adapted thereto are used as a counterpart for precisely mating a mechanically lockable plug connection with the inventive chassis connector by inserting the respective cable connector into the precisely fitting opening of the chassis connector. As a result of the mating of the plug connection, a signal transmission contact element of the chassis connector comes into contact with a signal transmission contact element counterpart on the cable connector side, whereby a signal transmission is provided across the plug connection.

The mounting plate has a mounting plate recess for the chassis connector and/or the cable connector, wherein the chassis connector is designed to be applied to and supported on an area of the mounting plate surrounding the mounting plate recess. In the following, the area facing from where (in the mounted state of the chassis connector) the cable connector can be brought to the chassis connector is referred to as the front side of the mounting plate. The opposite side of the mounting plate is referred to as the rear side of the mounting plate.

The “mounting plate” as used in the present invention may take various forms. For example, the mounting plate is a planar two-dimensional plate or a planar device part on a device intended for installation of the chassis connector (e.g., a speaker). For example, the mounting plate may also be formed by a part of a housing of a device. In particular, when the mounting plate is provided by a part of a device (e.g., a headlamp or speaker), in special embodiments the mounting plate may also have a curved (non-planar) shape. Accordingly, the chassis connector can then have such holes or fastening options which are matched to the shape of the mounting plate.

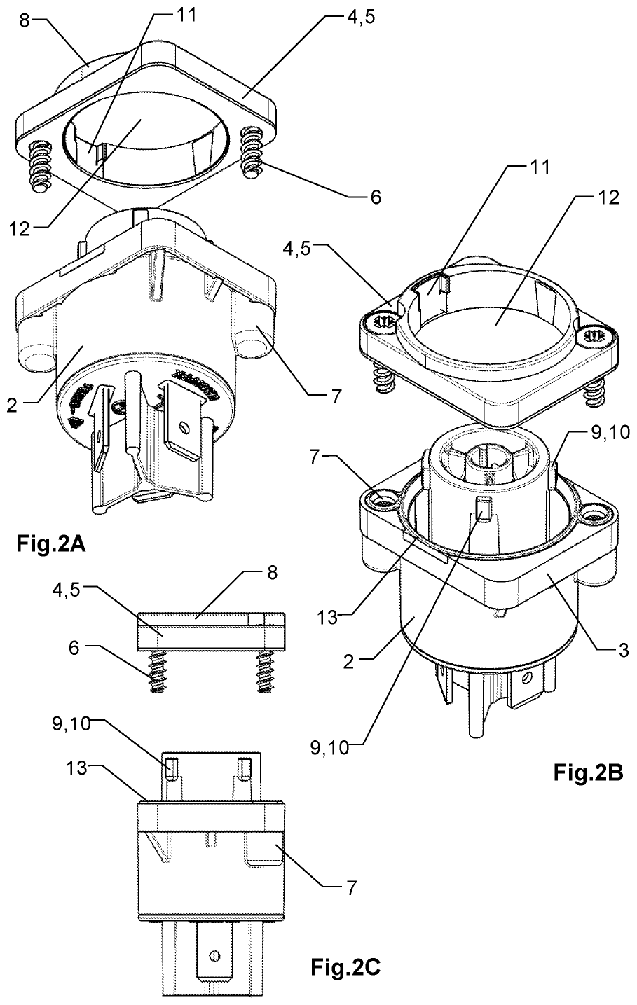

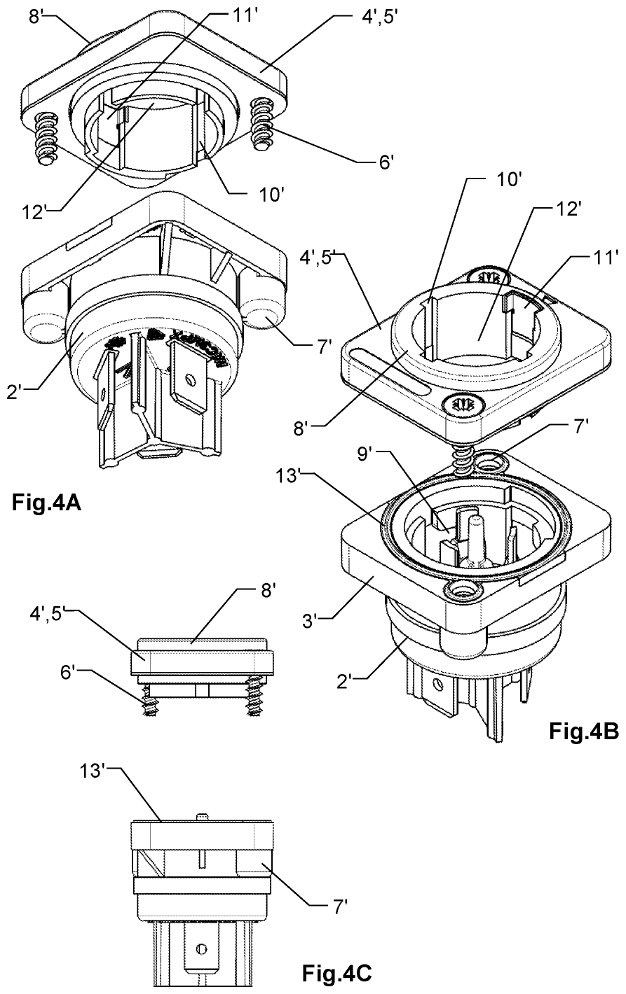

According to one aspect of the invention, the chassis connector is formed in two parts and comprises a first part and a second part which are provided for direct fastening to the mounting plate. For attachment, the first part has a first-part flange for engaging the rear side of the mounting plate and the second part has a second-part flange for engaging the front side of the mounting plate (see FIGS. 2A-2C and 4A-4C). For example, the first-part flange and the second-part flange have blind holes provided for mounting on the mounting plate, wherein each of the blind holes is provided to receive a fastening means, such as a screw or pin, coming from the mounting plate.

The two-part shape and the direct mounting of the second part on the mounting plate has, for example, the advantage that the second part can take over (or directly transfer to the mounting plate) a substantial support portion by means of a supporting skirt region in order to protect the chassis connector from loading forces acting on the cable connector perpendicular to the cable connector insertion direction when the cable connector is inserted (or at least partially inserted).

Furthermore, the two-part shape enables improved utilization of the possible space requirement for the opening, which is limited by the drilling and installation dimensions on the mounting plate that are fixed in the prior art. For example, a sheath wall penetrating the mounting plate recess can be dispensed with, so that the cross-section to be provided for the mating of the plug connection for the cable connector is limited exclusively by the mounting plate recess (and not by elements of the chassis connector).

In the case of prior art integral chassis connectors, such a sheath wall—i.e. an outermost wall which, when mounted on the mounting plate, projects into the mounting plate recess adjacent to the mounting plate inner wall—is typically used, for example, to develop a supporting effect against loading forces transverse to the insertion direction or to provide a latch socket on the front side of the mounting plate for blocking the bayonet lock. According to the invention, these functions can now be taken over by the second part, wherein the supporting skirt region described at the beginning leads to an increased support effect.

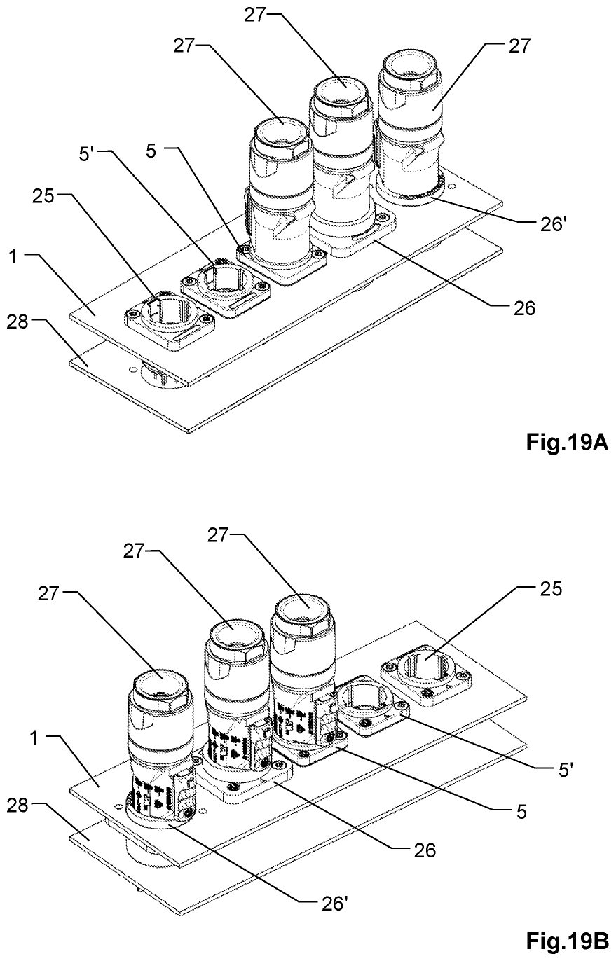

It is thus achieved that current output chassis connectors designed for power supply can be provided for mounting with hole and mounting dimensions of the more widely used power supply input connectors and audio connectors. Previously, power supply chassis connectors configured for signal output have larger hole and mounting dimensions than power supply chassis connectors configured for signal input (see, e.g., FIGS. 18A-18B, FIGS. 19A-19B). Thanks to the inventive two-part shape, the power supply output connectors can be adapted to the size of the other chassis connectors and thus meet the strict specifications with regard to the globally established installation dimensions for other connectors, which are often manufactured in the so-called D dimension, for example.

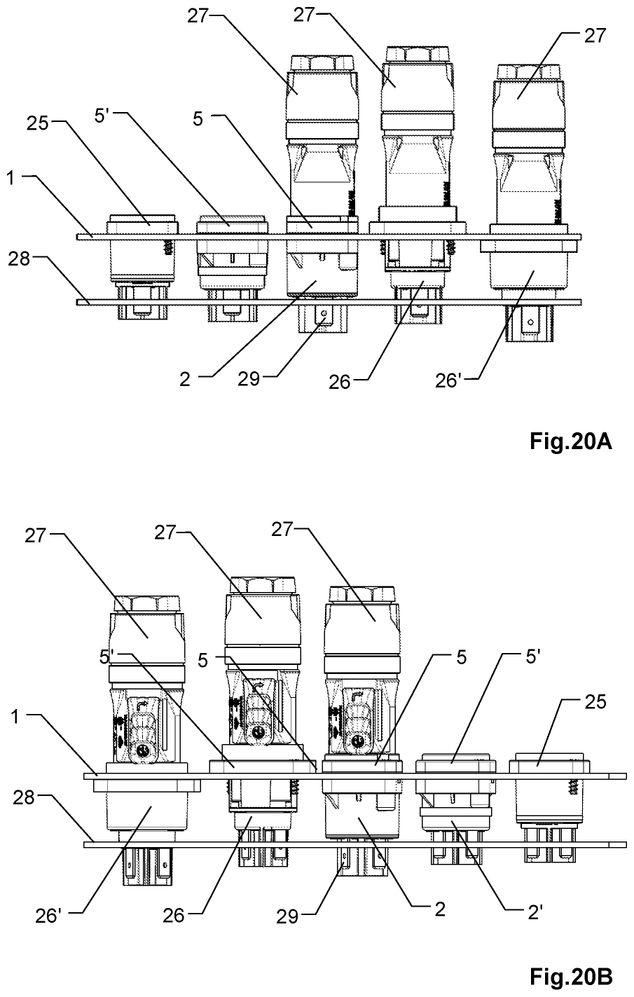

Another advantage of the two-part shape is increased flexibility with regard to the installation depth of the chassis connector, i.e. the extension of the chassis connector on the rear side of the mounting plate perpendicular to the mounting plate (see FIGS. 20A-20B). Since, for example, the cross-section to be provided for the plug connection for the cable connector is limited exclusively by the mounting plate recess and the supporting effect is increased by the supporting skirt region, the possible scope for selecting the penetration depth is increased. In this context, suitable selection of the thickness (in the insertion direction) of the second part and appropriate positioning of a latch socket can ensure that actuable latches of conventional cable connectors are arranged at the correct distance from the recess/latch socket and can thus engage in the recess/latch socket.

In the prior art, the penetration depth plays a role, for example, if the chassis connector is to be connected directly to a printed circuit board. In this case, a connection between the chassis connector and the printed circuit board is first made, e.g. by soldering, which is often not non-destructively detachable. Subsequently, the chassis connector can only be mounted to the mounting plate from the rear side of the mounting plate. Due to the rear mounting, the mounting depth of prior art chassis connectors of integral design is additionally increased, since the position of the flange is fixed (see FIGS. 20A-20B for a comparison of the mounting depth of prior art current signal output chassis connectors to be mounted on the front side and on the rear side for power supply). As a result, for example, current signal output connectors known in the prior art cannot be attached to a printed circuit board. Due to the reduced or adjustable mounting depth provided by the inventive chassis connector, the current signal output connector can now be brought to the same mounting depth as all other chassis connectors that meet this standard.

Another advantage—especially for the application of the chassis connector to a printed circuit board—is the provision of improved interchangeability, e.g. in case a chassis connector breaks. In the prior art, for example, the entire housing of a device in which the chassis connector is installed often has to be opened in order to separate the entire connector from the circuit board (since conventional chassis connectors are designed in one piece). This often involves a great deal of effort and is not possible in a non-destructive manner. In addition, it is often only the chassis connector parts on the insertion side that suffer damage, since they are directly exposed to external influences and play a key role in providing the mating and unmating function. It is precisely the insertion and removal process (i.e. from the cable connector into the chassis connector or out of it), which occurs in many repetitions (i.e. frequently), that causes wear to the chassis connector, wherein this wear is then reflected in and around the insertion opening of the chassis connector. Thanks to the two-part design of the chassis connector according to the invention, only the second part of the connector (which is stressed and exposed to wear) can be replaced individually/separately without great effort (and, for example, without opening the device in which the chassis connector is installed), whereas the unused first part can continue to be used.

Furthermore, the two-part shape also enables the use of a cover described at the beginning to seal the opening, for example, in the case of attaching the chassis connector to the underside of a printed circuit board. This would not be possible with conventional (integral) chassis connectors, as the chassis connectors have to be mounted from behind on the mounting plate in the case of attachment/soldering to the printed circuit board (as this has to be done before mounting on the flush-mounting plate) (a flange, especially not a flange with a cover, does not fit through the hole in the mounting plate due to its design).

As this, by the way, results throughout from the overall context of this disclosure or the technical teaching presented here anyway, the two-part design of the chassis connector according to the invention with first and second part is to be understood that the two parts (i.e. the bipartite nature) refer to the ready-to-install state of the chassis connector. The two parts of the chassis connector according to the invention (as well as analogously also the integral version from the prior art) are of course “internally” composed of several elements (individual components or individual parts)—connected and assembled within the scope of a manufacturing process. However, the two parts of the chassis connector according to the invention form two physical separate units/composites (i.e., so to speak, two physical separate pieces that are not connected to each other prior to mounting on the mounting plate) in the state intended for attachment to the mounting plate (i.e., in the state intended for installation in a corresponding device, e.g., audio/video device such as a large-format active loudspeaker system/an active floor-standing loudspeaker (for professional use in theaters or concert halls)). The two physical units/composites of the chassis connector according to the invention (i.e. the two pieces) are ultimately connected to each other (by means of the mounting plate) only after installation in the final device, and there in particular only by detachable fastening means (screw connection).

Further, the two-part shape allows for a lower manufacturing tolerance for the key element counterparts located on the second part, reducing wear of the key element counterparts due to frequent loosening and mating of the chassis connector and cable connector.

The production of the second part intended to be applied to the front side in a separate injection molding process enables a molded part to be used for the production of the key element counterparts to be pulled off in a direction which, in the assembled state of the chassis connector, corresponds to a direction facing toward the mounting plate. This makes it possible for the key element counterparts to have their smallest dimension at the location of the first contact with the key elements of the cable connector matched thereto and to be matched precisely to the dimensions of the key elements of the cable connector. This reduces wear of the key element counterparts due to frequent loosening and mating of the chassis connector and cable connector. For example, wear and tear and susceptibility for wear can be further reduced if the second part is made of metal (->made entirely of metal or made of metal at least at those areas/elements of the second part of the chassis connector which form the insertion opening for the cable connector).

According to a further aspect of the invention, the chassis connector is provided at least with a part or in its entirety by means of a flange to be applied to the front side of the mounting plate, wherein a fixedly arranged cover for the opening is arranged on the flange (see, e.g., FIGS. 11A-11D and 12A-12D). The cover is designed in a spring-loaded manner by means of a pivot joint in such a way that it independently strives for a closed position, wherein the cover has a sealing component in such a way that this sealing component seals the opening in the closed state of the cover. For example, the sealing component is designed for a seal according to IP65 or IP67. In particular, the sealing component is formed by means of a labyrinth seal (see aspects described below) and a combination of a sealing skirt to a sealing skirt counterpart (see aspects described below).

The cover has, for example, a spring which is wound around a pivot axis of the pivot joint, wherein the cover and the flange are matched to one another in such a way that the spring extends over at least two-thirds of the extension of the flange in the direction of the pivot axis. By increasing the extension of the spring, the number of coils of the spring can be increased. As a result, a higher pressing torque can be achieved in the closed state, while at the same time a more uniform or weaker increase in the restoring torque can be achieved when the cover is opened.

According to another aspect of the invention, the chassis connector also comprises a cover for the opening, for example of the type described above, wherein the cover comprises a sealing assembly having a sealing skirt and a sealing skirt counterpart (see, for example, FIGS. 11A-11D, 12A-12D and FIG. 30). For example, the sealing skirt counterpart is arranged around the opening on the flange and the sealing skirt is arranged around the cover. Alternatively, the sealing skirt is arranged around the opening at the flange and the sealing skirt counterpart is arranged at the cover. When the cover is closed, the sealing skirt is slipped over the sealing skirt counterpart in such a way that radial tension is created over the entire circumference of the sealing skirt by elastic deformation of the sealing skirt. This creates a sealing closure. To ensure that the tension is maintained over the entire circumference of the sealing skirt, thus preventing unwanted leakage, the sealing skirt and the sealing skirt counterpart each have a curved profile over their entire circumference and are convex in shape. For example, they are further shaped free of rectilinear sections.

According to another aspect of the invention, the chassis connector also comprises a cover for the opening, for example of the type described above, wherein the flange and the cover are adapted to each other in such a way that a labyrinth seal is formed which provides a first sealing stage with a throttling effect (see e.g. FIGS. 11A-11D, 12A-12D and 31). Furthermore, the chassis connector has a contact seal with an elastomeric sealing skirt and a sealing skirt counterpart, wherein the sealing skirt is adapted in its shape and dimensions to the sealing skirt counterpart in such a way that by slipping the sealing skirt over the sealing skirt counterpart, tension of the sealing skirt on the sealing skirt counterpart is created by elastic deformation of the sealing skirt (see, for example, FIGS. 11A-11D, 12A-12D and FIG. 30).

The labyrinth seal, for example, prevents splash water from hitting the elastomeric sealing skirt directly when the cover is closed. The labyrinth as such may not be tight in itself, but it lowers the energy of the water hitting the sealing skirt so that the sealing skirt is not lifted by splash water.

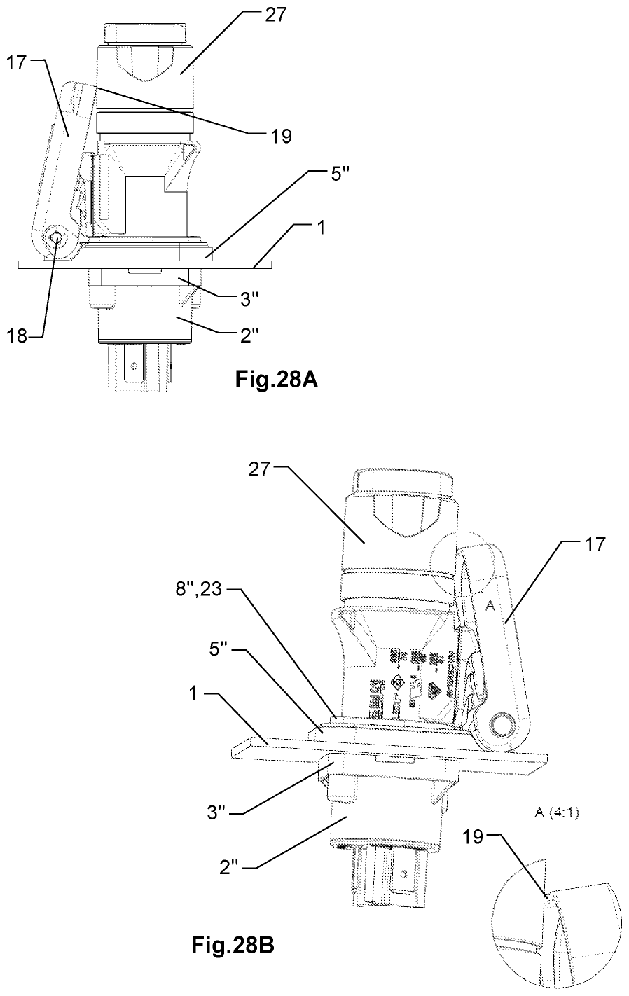

For example, the cover is designed in such a way that when the cable connector is plugged in (and thus the cover is open), an element of the cover which is hard compared to the sealing skirt (not formed as an elastomer) is in contact with the cable connector (see FIGS. 28A-28B). The hard-formed element of the cover is, for example, a cover-side part of the labyrinth seal. Thus, the elastomeric sealing skirt does not rest directly on the cable connector (and is not pressed and deformed against the cable connector by spring action). This prevents damage to the elastomer sealing skirt.

FIG. 1 shows an exemplary embodiment of a current signal output chassis connector mounted on a mounting plate 1 according to the invention, in a perspective view from the rear side of the mounting plate (FIG. 1A), in a perspective view from the front side of the mounting plate (FIG. 1B), in a side view (FIG. 1C), and in a top view of the front side of the mounting plate (FIG. 1D).

The chassis connector is formed in two parts. A first part 2 has a first-part flange 3 to be applied to the rear side of the mounting plate 1 and a second part 4 has a second-part flange to be applied to the front side of the mounting plate 1. The part-flanges 3, 5 have drill holes for mounting on the mounting plate, and in the embodiment shown the part-flanges are screwed together by means of screws 6. For this purpose, the first-part flange 3 has blind holes 7 to receive the screws 6 coming from the mounting plate.

The second part 4 further has a supporting skirt region 8, which provides a supporting effect for the cable connector inserted into the chassis connector with respect to loading forces acting on the cable connector perpendicular to the axial direction (perpendicular to the cable connector insertion direction). By means of the direct fastening of the second part 4 to the mounting plate 1, supporting forces applied by the supporting skirt region 8 and counteracting the loading forces are at least partially carried by the mounting plate 1.

The first part 2 has retaining elements 9 designed as lugs, which are engaged behind by grooves on the cable connector side as part of a locking mechanism in the plugged-in state, whereby the cable connector is blocked against axial extraction. The retaining elements 9, which are designed as lugs, also serve as key counterparts 10, which interact with key elements of the cable connector matched thereto in such a way that the cable connector can be inserted into the chassis connector in only one specific rotational orientation specified by the key counterparts 10.

The second part 4 further comprises a latch socket 11, which is provided for engagement by a latch of the cable connector as part of the locking mechanism, thereby locking the cable connector with respect to rotation in the unscrewing direction.

FIG. 2 shows two different perspective views (FIG. 2A, FIG. 2B) and a side view (FIG. 2C) of the mutually separated individual parts of the current signal output chassis connector shown in FIGS. 1A-1D. In this separated view, the opening 12 of the chassis connector for the cable connector is now further visible. In addition, it can be seen that the cross-sectional area to be provided for the cable connector for the mating of the plug connection, i.e. the minimum mounting plate recess dimension, is limited only by the cable connector in the shown embodiment of the chassis connector, because the chassis connector is free of a sheath element which, when mounted on the mounting plate, projects into or through the mounting plate recess abutting the inner wall of the mounting plate, thereby delimiting an inner region of the connector from the sheath element against the inner wall of the mounting plate recess. In other words, the mounting plate recess for mounting the chassis connector substantially corresponds to the largest cross-section of the cable connector to be passed through the recess for mating the plug connection.

Furthermore, a sealing element 13 of the first-part flange 3 enclosing the opening 12 is now visible in the split view, which creates a sealing effect by pressing against the mounting plate when the chassis connector is applied to the mounting plate. For example, this sealing element 13 is formed in one piece with the first-part flange 3, wherein the combination of the sealing element 13 and the first-part flange 3 has been produced by means of two-component injection molding.

FIG. 3 shows an exemplary embodiment of a current signal input chassis connector mounted on a mounting plate 1 according to the invention, in a perspective view from the back of the mounting plate (FIG. 3A), in a perspective view from the front side of the mounting plate (FIG. 3B), in a side view (FIG. 3C), and in a top view of the front side of the mounting plate (FIG. 3D).

The chassis connector is made in two parts and has a first part 2′ with a first-part flange 3′ to be applied to the rear side of the mounting plate 1 and a second part 4′ with a second-part flange 5′ to be applied to the front side of the mounting plate 1. The part flanges 3′, 5′ have drill holes for mounting on the mounting plate, wherein the part flanges are screwed together by means of screws 6′. For this purpose, the first-part flange 3′ has blind holes 7′ to accommodate the screws 6′ coming from the mounting plate. The second part 4′ also has a supporting skirt region 8′ surrounding the opening 12′ for the cable connector, which provides a supporting effect as described at the beginning for the chassis connector in FIG. 1.

The first part 2′ has key counterparts 10′ formed as grooves, wherein the grooves first extend axially, thereby providing a rotational alignment for insertion of the cable connector into the chassis connector, and then extend normal to the axis (normal to the direction of insertion of the cable connector into the chassis connector) or slightly oblique to normal to the axis and serve in this region as a retaining component 9′. Here, the retaining element counterpart or the key elements on the side of the cable connector are then designed as a lug assembly which can be inserted into the grooves when the cable connector is correctly rotationally aligned, wherein in an end position the lugs in the groove area extending normally or slightly obliquely to normal to the axis then cause the cable connector to be blocked against axial extraction.

The second part 4′ further comprises a latch socket 11′ which—as described above for the cable connector of FIG. 1—is provided for engagement by a latch of the cable connector as part of a locking mechanism.

FIG. 4 shows two different perspective views (FIG. 4A, FIG. 4B) and a side view (FIG. 4C) of the mutually separate individual parts of the current signal input chassis connector shown in FIGS. 3A-3D. Here, too, the chassis connector has a sealing element 13′ of the first-part flange 3′ enclosing the opening 12′, which creates a sealing effect by pressing against the chassis connector when the chassis connector is applied to the mounting plate.

FIG. 5 shows a perspective view (FIG. 5A) into the opening 12 of the current signal output chassis connector shown in FIGS. 1A-1D, and a perspective view (FIG. 5B) into the opening of the current signal input chassis connector shown in FIGS. 3A-3D.

With reference to the current signal output chassis connector shown in FIGS. 1A-1D, four key counterparts 10 or retaining components 9 formed as lugs can be seen here in particular.

With reference to the current signal input chassis connector shown in FIGS. 3A-3D, four grooves serving as key counterparts 10′ and retaining components 9′, respectively, can be seen here. The grooves extend axially in a first section 14 intended to function as key counterparts 10′, and then transition to a course normal or slightly oblique to normal to the axis in a second section 15 intended to function as retaining components 9′. One of the grooves also serves as a latch socket 11′, which is provided for engagement of a latch of the cable connector provided as part of a locking mechanism.

Further, signal transmission contact elements 16 are visible in the view, which are configured to contact a cable-connector-side signal transmission contact element counterpart by mating the plug connection.

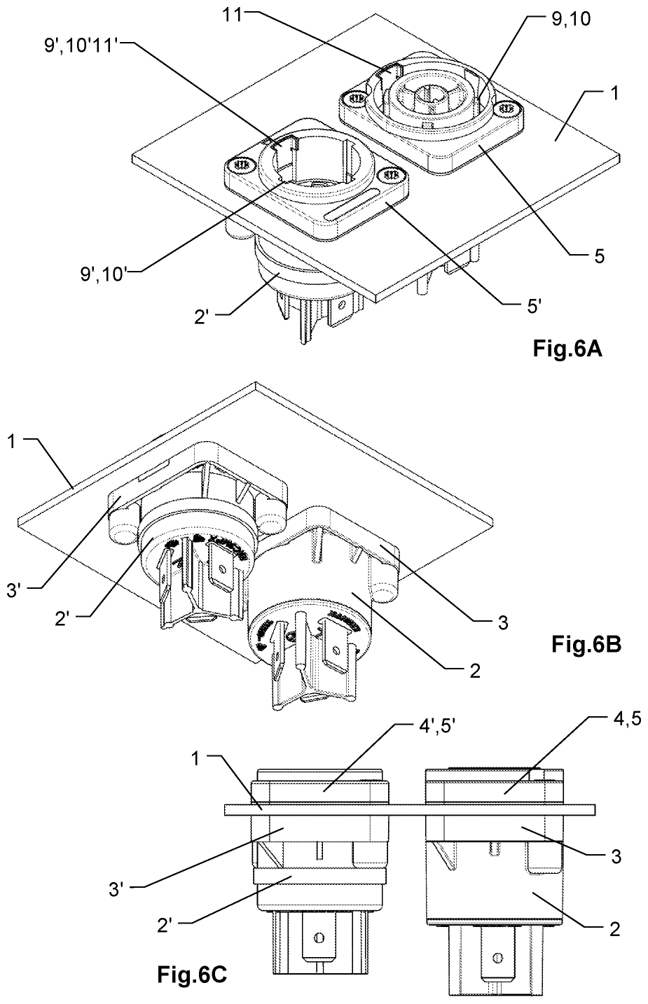

FIG. 6 shows a current signal output chassis connector according to FIG. 1A-1D, which is mounted next to a current signal input chassis connector according to FIG. 3A-3D on a mounting plate 1 in a perspective view from the front side of the mounting plate 1 (FIG. 6A), in a perspective view from the rear side of the mounting plate (FIG. 6B), and in a side view (FIG. 6C).

Both connectors are designed according to the so-called D dimension, i.e. the respective first-part flanges 3, 3′ and second-part flanges 5, 5′ have edge lengths of 26 mm (flange width) to 31 mm (flange length) and the mounting plate drill hole (the mounting plate recess) has a diameter between 23.6 and 24 mm.

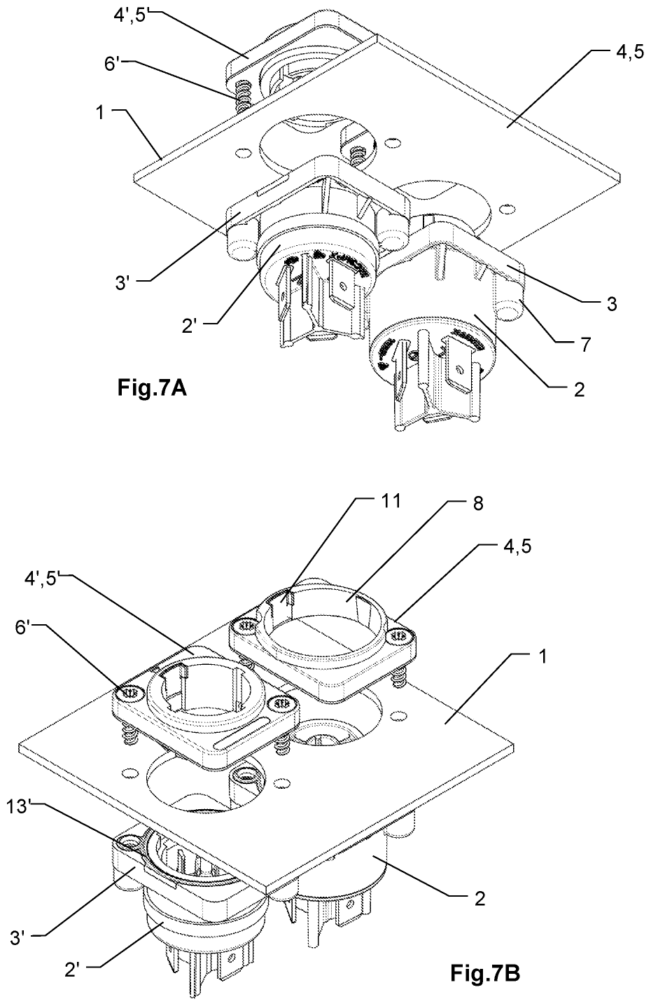

FIG. 7 shows the chassis connector assembly of FIG. 6, as it is intended to be mounted on the mounting plate, in a perspective view from the rear side of the mounting plate 1 (FIG. 7A) and in a perspective view from the front side of the mounting plate (FIG. 7B).

For both chassis connectors, the respective two-part shape and the division into respective first parts 2, 2′ and second parts 4, 4′ can be seen. In particular, thanks to the two-part shape, both chassis connectors, i.e. also the current output connector, can now be manufactured in D dimension and thus a mounting plate bore that is uniform for both connector types can be used.

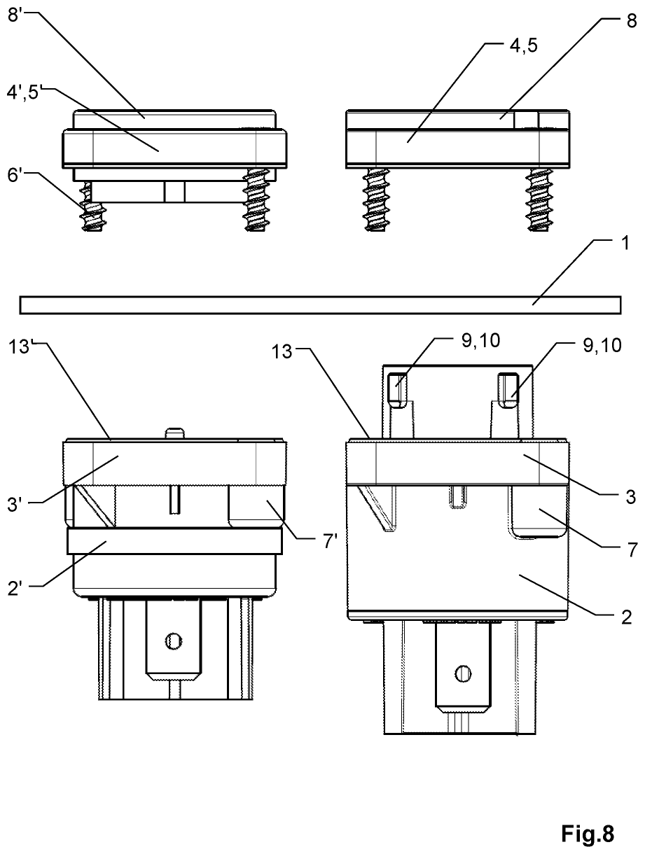

FIG. 8 shows a side view of the chassis connector assembly of FIG. 6 as it is intended to be mounted on the mounting plate.

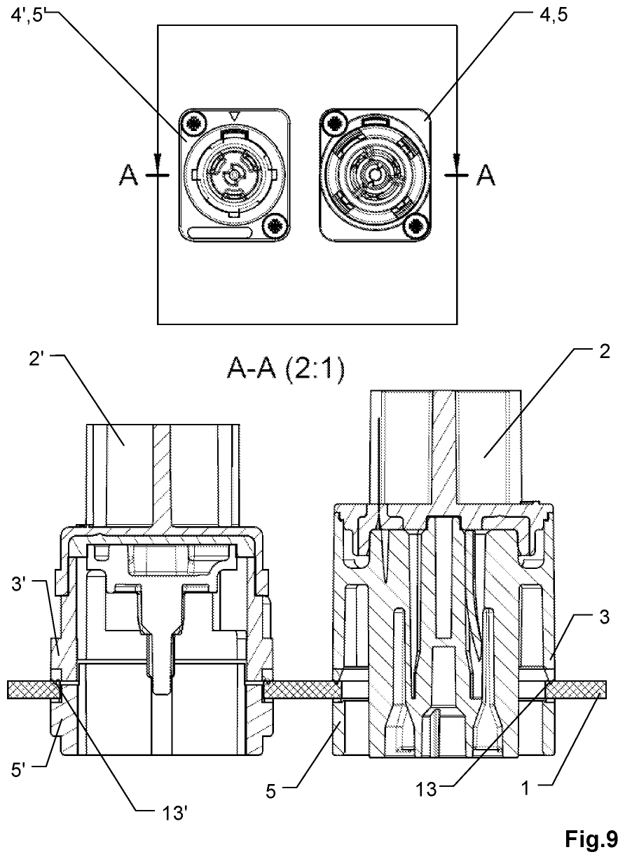

FIG. 9 shows a sectional view of both chassis connectors mounted on mounting plate 1 as shown in FIG. 6. In the figure, among other things, the press seals 13, 13′ of the respective first-part flanges 3, 3′ to the mounting plate 1 can be seen. Moreover, with respect to the current output chassis connector, it is readily apparent that the first-part flange 3 and the second-part flange 5 are free of a sheath element projecting into the mounting plate recess and that the extension of the opening of the first-part flange 3 and the second-part flange 5 in the direction of section substantially corresponds to the extension of the mounting plate recess. In other words, the mounting plate recess for mounting the chassis connector substantially corresponds to the largest cross-section of the cable connector to be passed through the recess for the mating of the plug connection.

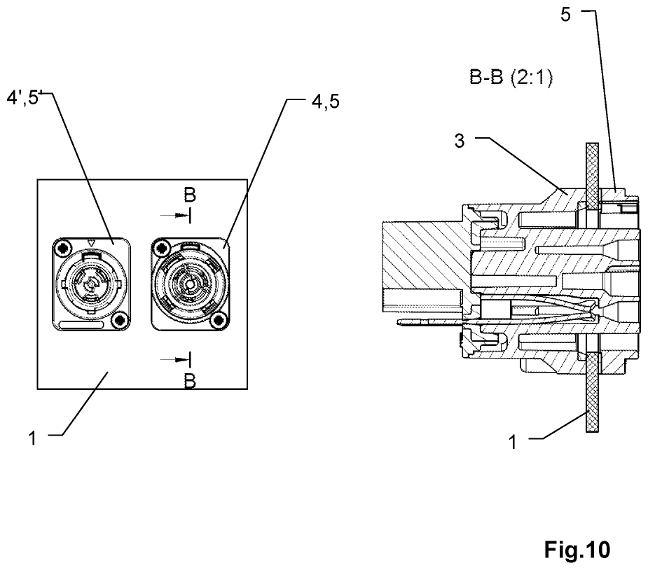

FIG. 10 shows a section through the current signal output chassis connector mounted to mounting plate 1 shown in FIG. 6, with the section line rotated ninety degrees from the section shown in FIG. 9.

FIG. 11 shows another exemplary embodiment of a current signal output chassis connector mounted on a mounting plate 1 according to the invention, in a perspective view from the rear side of the mounting plate (FIG. 11A), in a perspective view from the front side of the mounting plate (FIG. 11B), in a side view (FIG. 11C), and in a top view of the front side of the mounting plate (FIG. 11D).

In its basic structure, the chassis connector is designed like the chassis connector shown in FIGS. 1A-1D, i.e. in two parts with a first part 2″, which has a first-part flange 3″ for being applied to the rear side of the mounting plate 1, and a second part 4″, which has a second-part flange 5″ for being applied to the front side of the mounting plate 1. The part flanges 3″, 5″ have drill holes for mounting on the mounting plate, and in the embodiment shown the part flanges are screwed together by means of screws 6″. For this purpose, the first-part flange 3″ has blind holes 7″ to receive the screws 6″ coming from the mounting plate.

The second part 4″ further has a supporting skirt region 8″, which provides a supporting effect for the cable connector inserted into the chassis connector with respect to loading forces acting on the cable connector perpendicular to the axial direction (perpendicular to the cable connector insertion direction). By means of the direct fastening of the second part 4″ to the mounting plate 1, supporting forces applied by the supporting skirt region 8″ and counteracting the loading forces are at least partially carried by the mounting plate 1.

The first part 2″ has retaining elements 9″ designed as lugs, which are engaged behind by grooves on the cable connector side as part of a locking mechanism in the plugged-in state, whereby the cable connector is blocked against axial extraction. The retaining elements 9″ designed as lugs also serve as key counterparts 10″, which interact with key elements of the cable connector matched thereto in such a way that the cable connector can be inserted into the chassis connector in only one specific rotational orientation predetermined by the key counterparts 10″.

The second part 4″ further comprises a latch socket 11″ which is provided for engagement by a latch of the cable connector as part of the locking mechanism, thereby locking the cable connector with respect to rotation in the unscrewing direction.

In this embodiment, the second part 4″ also has a cover 17 for the opening, which is fixed to the second-part flange 5″. The cover is spring-loaded by means of a pivot joint 18 in such a way that it independently strives for a closed position.

The cover 17 is designed for sealing according to IP65 and for this purpose has a labyrinth seal, which provides a first sealing stage with a throttling effect, and a contact seal with an elastomeric sealing component, which provides a sealing stage downstream of the first sealing stage.

To create the labyrinth seal, the cover 17 and the second-part flange 5″ are matched to one another in such a way that, when the cover 17 is closed, an edge element 19 of the cover arranged around the opening 12″ rests on a cover edge bearing surface 20 of the second-part flange 5″. The second-part flange 5″ further has an elevation 21 on the inside of the cover edge bearing surface 20, so that by resting the cover edge element 19 on the cover edge bearing surface 20, the elevation 21 protrudes into the cover 17 to provide a labyrinth sealing effect.

For the second sealing stage, the cover 17 has an elastomeric sealing skirt 22 and a sealing skirt counterpart 23 arranged on the elevation 21 (which, for example, at the same time forms part of the supporting skirt region 8″), wherein the sealing skirt 22 is matched in its shape and dimensions to the sealing skirt counterpart 23 in such a way that, by slipping the sealing skirt 22 over the sealing skirt counterpart 23, tension of the sealing skirt 22 on the sealing skirt counterpart 23 is produced by elastic deformation of the sealing skirt 22.

In the embodiment shown, the sealing skirt counterpart 23 or the sealing skirt 22 encloses the bores provided for mounting the second-part flange 5″ on the mounting plate 1. The bores of the second-part flange, which lead into the blind bores 7″ of the first-part flange, are thus located within the circumference of the sealing skirt counterpart 23 or the sealing skirt 22 and are thus sealed in the same way as the opening 12″.

FIG. 12 shows another exemplary embodiment of a current signal input chassis connector mounted on a mounting plate 1 according to the invention, in a perspective view from the rear side of the mounting plate (FIG. 12A), in a perspective view from the front side of the mounting plate (FIG. 12B), in a side view (FIG. 12C), and in a top view of the front side of the mounting plate (FIG. 12D).

The chassis connector is made in two parts and has a first part 2′″ with a first-part flange 3′″ to be applied to the rear side of the mounting plate 1 and a second part 4′″ with a second-part flange 5′″ to be applied to the front side of the mounting plate 1. The part flanges 3′″, 5′″ have drill holes for mounting on the mounting plate, whereby the part flanges are screwed together by means of screws 6′″. For this purpose, the first-part flange 3′″ has blind holes 7′″ to receive the screws 6′″ coming from the mounting plate. The second part 4′″ also has a supporting skirt region 8′″ surrounding the opening 12′″ for the cable connector, which provides a supporting effect as described at the beginning for the chassis connector of FIG. 1.

The first part 2′″ has key counterparts 10′″ formed as grooves, wherein the grooves first extend axially, and thereby provide a rotational alignment for insertion of the cable connector into the chassis connector, and then extend normal to the axis (normal to the direction of insertion of the cable connector into the chassis connector) or slightly oblique to normal to the axis and serve in this area as a retaining component 9′″. Here, the retaining element counterpart or the key elements on the side of the cable connector are then designed as a lug assembly which can be inserted into the grooves when the cable connector is correctly rotationally aligned, wherein in an end position the lugs in the groove area extending normally or slightly obliquely to normal to the axis then cause the cable connector to be blocked against axial extraction.

The second part 4′″ further comprises a latch socket 11′″, which—as described at the beginning for the cable connector of FIG. 1—is provided for an engagement of a latch of the cable connector provided within the scope of a locking mechanism.

Furthermore, the second part 4′″ has a cover 17′ for the opening, which is fixed to the second-part flange 5′″. The cover is spring-loaded by means of a pivot joint 18′ in such a way that it independently strives for a closed position.

The cover 17′ has a labyrinth seal as described in initially with respect to the cable connector in FIG. 11, which provides a first sealing stage with a throttling effect, and a contact seal with an elastomeric sealing component, which provides a sealing stage downstream of the first sealing stage. For this purpose, the cover 17′ has an edge element 19′ arranged around the opening 12′″, which is intended to be applied to a cover edge bearing surface 20′ of the second-part flange 5′″. The second-part flange 5′″ further has an elevation 21′ on the inside of the cover edge bearing surface 20′, so that by resting the cover edge element 19′ on the cover edge bearing surface 20′, the elevation 21′ protrudes into the cover 17′ to provide a labyrinth sealing effect.

For the second sealing stage, the cover 17′ has an elastomeric sealing skirt 22′ and a sealing skirt counterpart 23′ arranged on the elevation 21′ (which, for example, simultaneously forms part of the supporting skirt region 8′″), wherein the shape and dimensions of the sealing skirt 22′ is matched to the sealing skirt counterpart 23′ in such a way that, when the sealing skirt 22′ is slipped over the sealing skirt counterpart 23′, tension of the sealing skirt 22′ on the sealing skirt counterpart 23′ is produced by elastic deformation of the sealing skirt 22′.

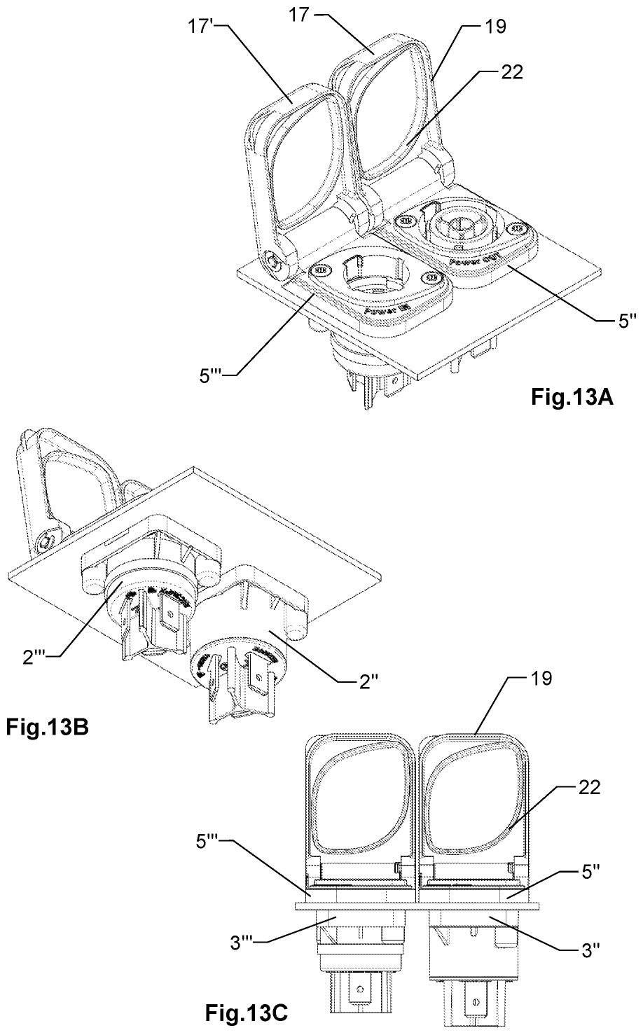

FIG. 13 shows a current signal output chassis connector according to FIGS. 11A-11D, which is mounted next to a current signal input chassis connector according to FIGS. 12A-12D on a mounting plate 1, in a perspective view from the front side of the mounting plate 1 (FIG. 13A), in a perspective view from the rear side of the mounting plate (FIG. 13B), and in a side view (FIG. 13C).

Both connectors are designed according to the so-called D dimension.

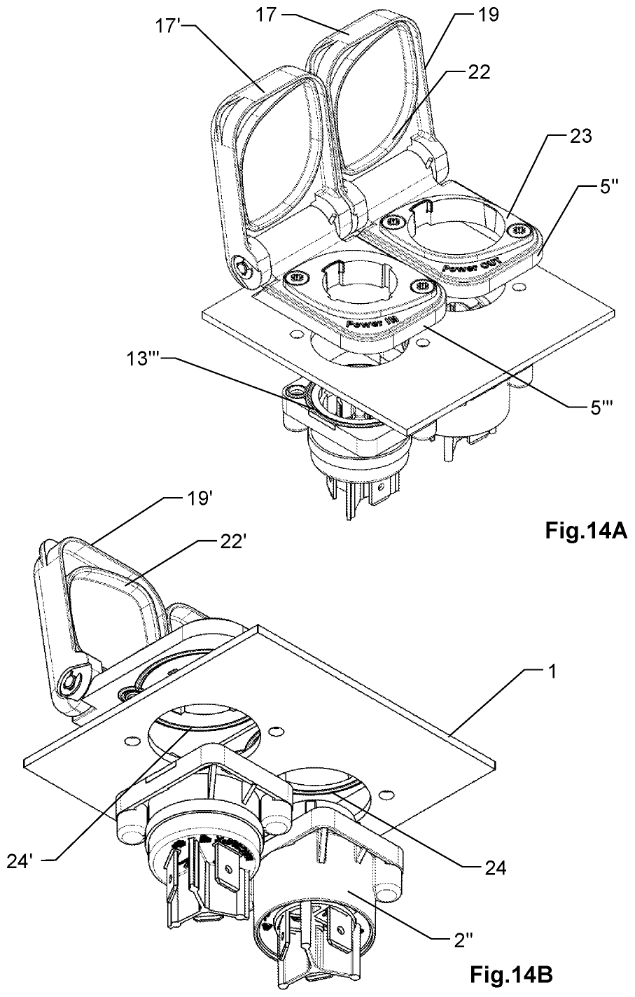

FIG. 14 shows the chassis connector assembly of FIG. 13, as it is intended to be mounted on the mounting plate, in a perspective view from the front side of the mounting plate 1 (FIG. 14A) and in a perspective view from the rear side of mounting plate (FIG. 14B).

The respective two-part shape and the division into respective first parts 2″, 2′″ and second parts 4″, 4′″ can be seen for both chassis connectors. In particular, thanks to the two-part shape, both chassis connectors, i.e. also the current output connector including cover 17,17′, can now be manufactured in D dimension and thus a mounting plate bore that is uniform for both connector types can be used.

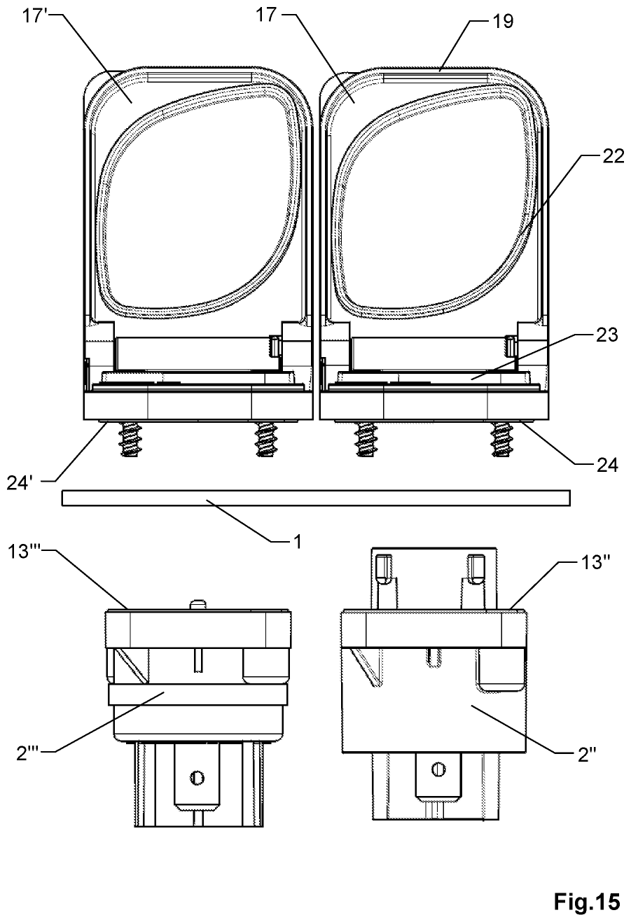

FIG. 15 shows a side view of the chassis connector assembly of FIG. 13 as it is intended to be mounted on the mounting plate.

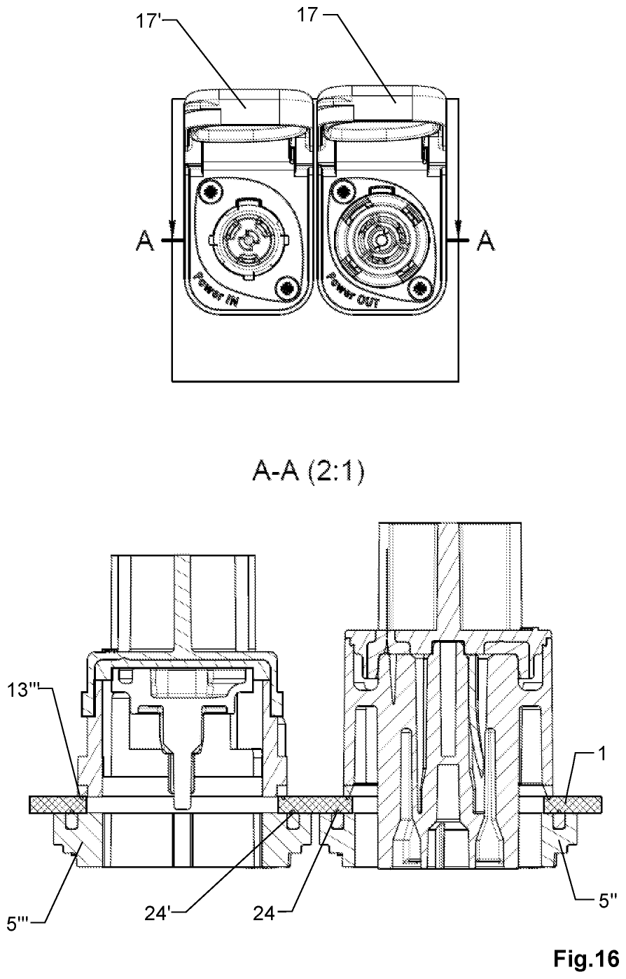

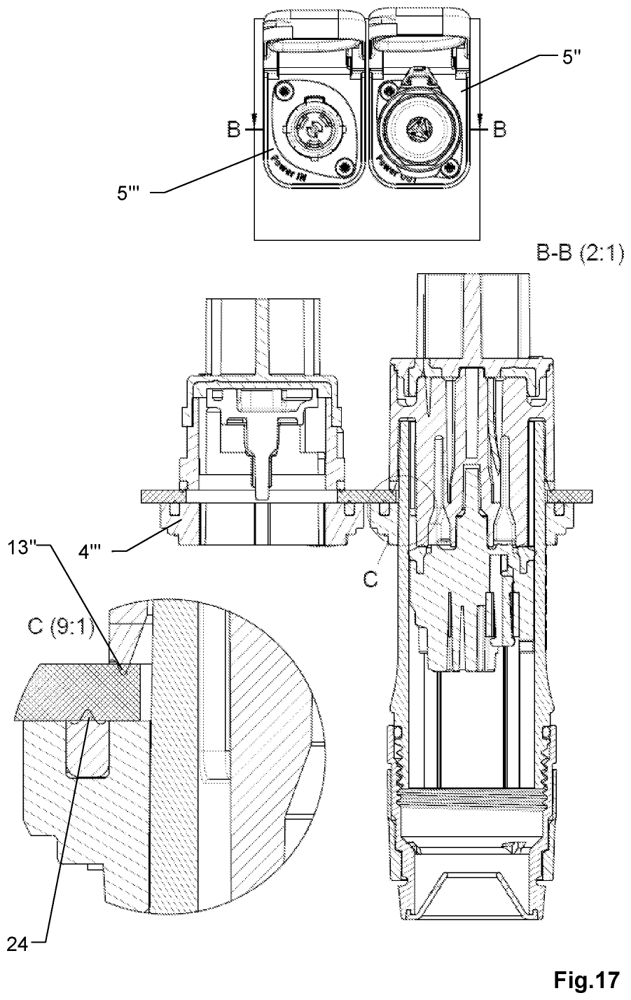

FIG. 16 shows a sectional view of both chassis connectors mounted on the mounting plate 1 as shown in FIG. 13. In the figure, among other things, the press seals 13″, 13′″ of the respective first-part flanges 3″, 3′″ to the mounting plate 1 can be seen. In the embodiment, furthermore, the respective second-part flanges 5″, 5′″ also have press seals 24, 24′ (formed integrally with the flanges), which is again specially emphasized in FIG. 17.

FIG. 17 shows again the sectional view of FIG. 16, but here a cable connector is inserted in the current output plug and the press seals 13″, 24, which are formed integrally with the flanges of the current output plug, are emphasized.

FIG. 18 shows an arrangement of a prior art current signal input chassis connector 25, the prior art current signal input chassis connector shown in FIGS. 3A-3D, the prior art current signal output chassis connector shown in FIGS. 1A-1D, and a prior art current signal output chassis connector 26. A prior art cable connector 27 is also plugged into each of the two current signal output chassis connectors. The assembly is shown on the one hand in a perspective view (FIG. 18A) from the front side of the mounting plate 1 and on the other hand in a side view (FIG. 18B).

The prior art current signal input chassis connector 25 and the two chassis connectors according to the present invention each meet the requirements for the so-called D dimension. However, the prior art current signal output chassis connector 26 has larger dimensions for this purpose. In the prior art, the chassis connectors 25, 26 are formed in one piece.

FIG. 19 again shows the assembly of connectors shown in FIG. 18 in two different perspective views, wherein the assembly is supplemented by a further prior art current signal output chassis connector 26′. The further prior art current signal output chassis connector 26′ is formed identically to the other prior art current signal output chassis connector 26, but is mounted on the mounting plate 1 from the rear side of the mounting plate 1.

Rear mounting is necessary, for example, if the chassis connectors are to be soldered to a printed circuit board 28. Typically, the connectors are first soldered to the printed circuit board 28 for this purpose and can then only be brought up to the back of the mounting plate and attached to the mounting plate (the prior art chassis connectors 25, 26 are designed as a single piece). The rear mounting increases the installation depth (see FIG. 20).

Again, prior art cable connectors 27 are inserted in each of the current signal output chassis connectors.

FIG. 20 shows two side views of the chassis connector and cable connector assembly shown in FIG. 19. The distance of the printed circuit board 28 from the mounting plate 1 used in practice is often standardized and corresponds approximately to the distance shown in the figure. In this case, the distance is too close for problem-free attachment of the conventional current signal output chassis connector 26, 26′. If the chassis connector 26′ is mounted backwards on the mounting plate 1 and the widely standardized distance between the printed circuit board 28 and the mounting plate 1 is to be maintained, the connector housing already rests on (or rather already penetrates) the printed circuit board 28. This is a known problem for prior art current signal output chassis connectors.

Due to the two-part design of the current signal output chassis connector according to the invention, the installation depth (extension of the chassis connector extending from the rear side of the mounting plate) can now be reduced so that the extension of the connector housing (here of the first part 2 arranged on the rear side of the mounting plate 1) is less than the distance to be maintained and thus sufficient space is still available for soldering the contacts 29 on the chassis connector side.

FIG. 21 shows a perspective view from the front side of the mounting plate 1 of another chassis connector and cable connector assembly, wherein a prior art current signal input chassis connector 25, the current signal input chassis connector shown in FIGS. 12A-12D, the current signal output chassis connector shown in FIGS. 11A-11D, and a prior art current signal output chassis connector 26 are arranged side by side. A prior art cable connector 27 is also inserted in each of the two current signal output chassis connectors.

Again, the conventional current signal input chassis connector 25 and the two chassis connectors according to the present invention each meet the requirements for the so-called D dimension.

FIG. 22 shows three different side views of a prior art current signal input cable connector 27 (FIG. 22A, FIG. 22B, FIG. 22C), a top view from the mounting plate when the plug is inserted into the chassis connector (FIG. 22D) and a top view towards the mounting plate when the plug is inserted into the chassis connector (FIG. 22E).

The cable connector has a latch slider 30 with a latch 31 provided for latching into a latch socket 11, 11″ of the current signal output chassis connector. Furthermore, four key elements 32 are visible, here formed as grooves, which are provided for interaction with key counterparts 10, 10″ of the chassis connector formed as lugs.

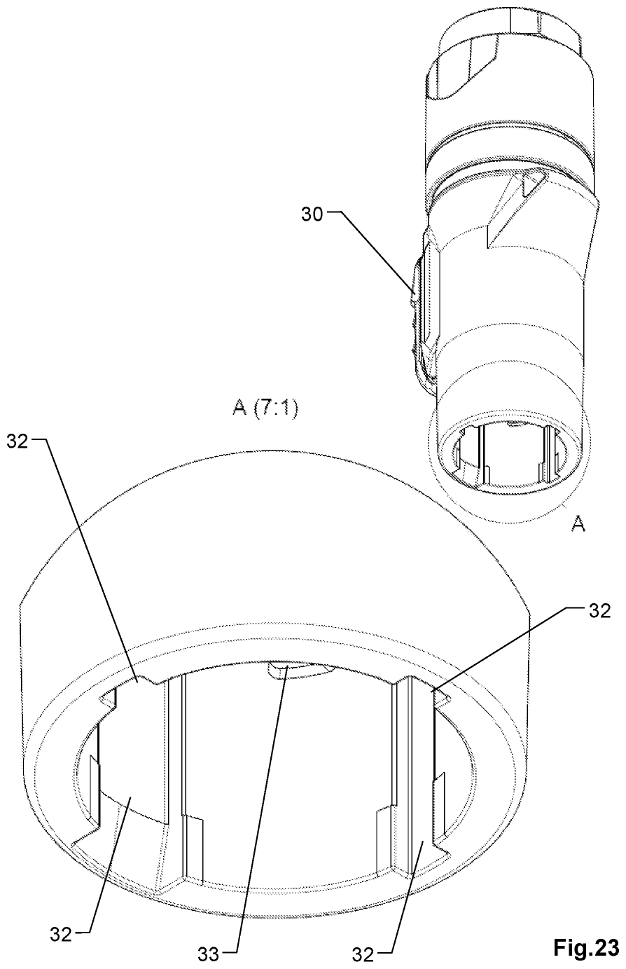

FIG. 23 shows a perspective view of the current signal input cable connector of FIGS. 21A-21E, with the side intended for insertion into the chassis connector highlighted here. In the highlighted part, a section 33 extending normal to the axis or slightly oblique to normal to the axis is just visible for one of the grooves, which in a locking position engages behind a key counterpart 10, 10″ formed as a lug of the chassis connector, whereby an inadvertent axial extraction of the cable connector is blocked.

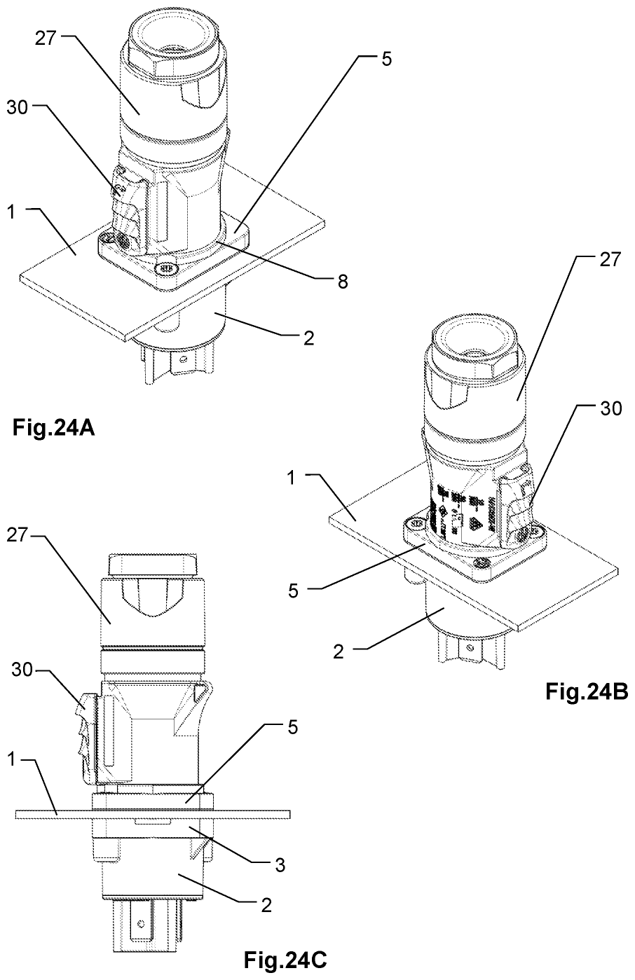

FIG. 24 shows the current signal output chassis connector shown in FIGS. 1A-1D with the cable connector counterpart 27 inserted in two perspective views from the front side of the mounting plate 1 (FIG. 24A, FIG. 24B), and in a side view (FIG. 24C). Here, the latch slider 30 or the latch 31 of the cable connector 27 is in the latched position, so that turning back (against the screwing-in direction) of the cable connector is blocked.

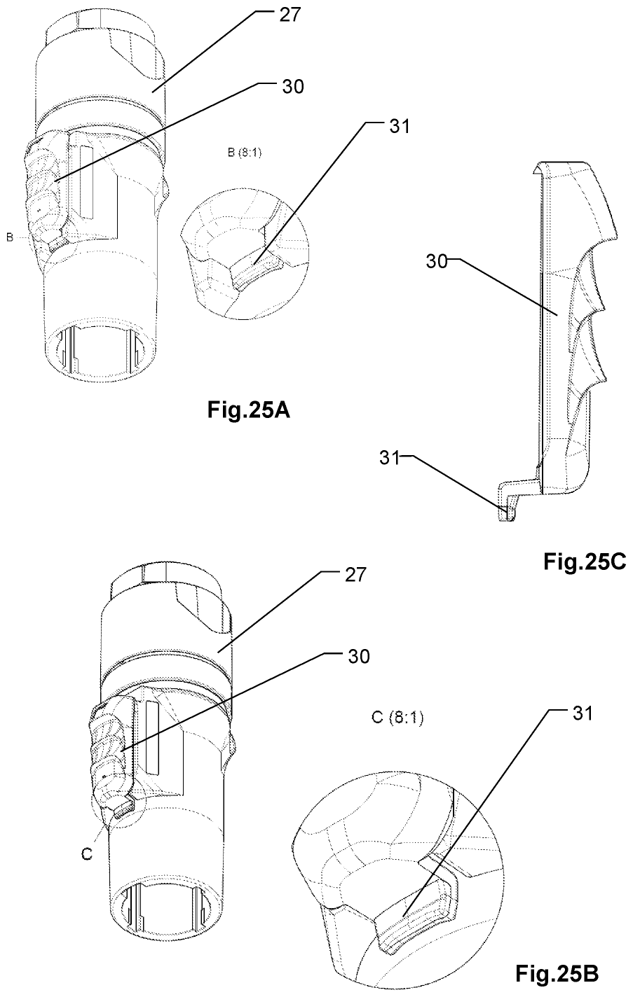

FIG. 25 shows two perspective views of the cable connector 27 shown in FIGS. 22A-22E, with the latch slider 30 or latch 31 of the cable connector 27 being shown in one view (FIG. 25A) in the open (unlatched) position and in the other view (FIG. 25C) in the latched position. Furthermore, the figure shows a side view (FIG. 25B) of the latch slider 30 with latch 31.

FIG. 26 shows three different side views of a prior art current signal output cable connector 34 (FIG. 26A, FIG. 26B, FIG. 26C), a top view from the mounting plate when the plug is inserted into the chassis connector (FIG. 26D) and a top view towards the mounting plate when the plug is inserted into the chassis connector (FIG. 26E).

The cable connector has a latch slider 30′ with a latch 31′ provided for latching into a latch socket 11′, 11′″ of the current signal input chassis connector. Furthermore, four key elements 32′ are visible, here formed as lugs, which are provided for cooperation with key counterparts 10′, 10′″ of the chassis connector formed as grooves.

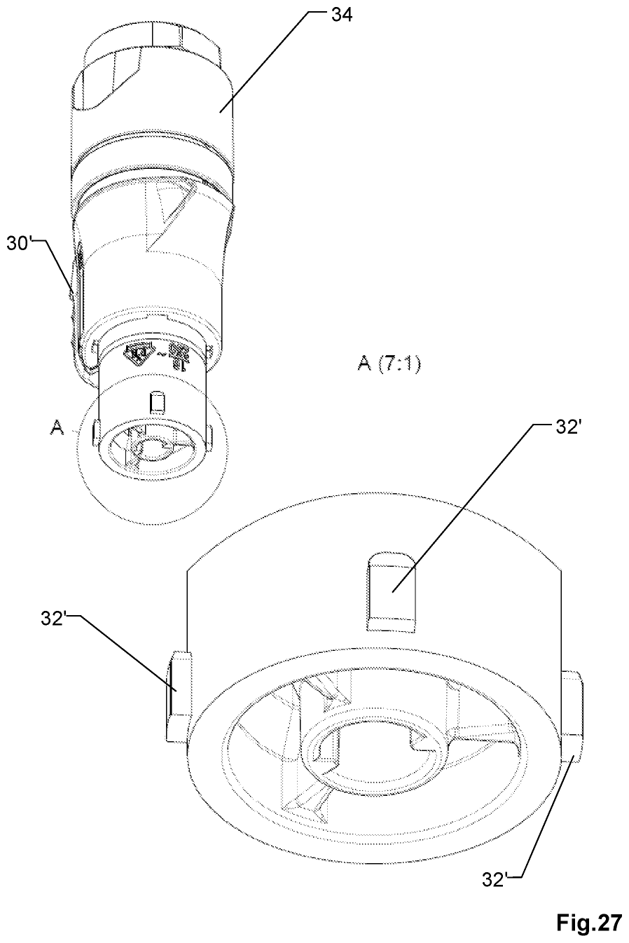

FIG. 27 shows a perspective view of the current signal output cable connector 34 of FIGS. 26A-26E, with the side intended for insertion into the chassis connector being highlighted here. Here, the lugs serve as key elements 32′ as well as for blocking an axial extraction of the cable connector in a completely screwed-in state, when the lugs are then located in grooves of the chassis connector extending perpendicularly or slightly obliquely to the axis.

FIG. 28 shows the current signal output chassis connector shown in FIGS. 11A-11D with the cable connector 27 inserted in a side view (FIG. 28A) and in a perspective view (FIG. 28B), with the position of the cover 17 pressing against the cable connector 27 being highlighted. The cover is spring-loaded by means of a pivot joint 18 in such a way that it independently strives for a closed position and therefore presses against the cable connector 27 when the cable connector is inserted.

In accordance with one aspect of the invention, a hard cover edge 19 (as compared to the elastomeric sealing skirt 22) rests on the cable connector, wherein the cover edge 19 resting on the cable connector is provided, for example, to contribute to a labyrinth seal when the cover is closed to dampen splashing water before it strikes the sealing skirt 22.

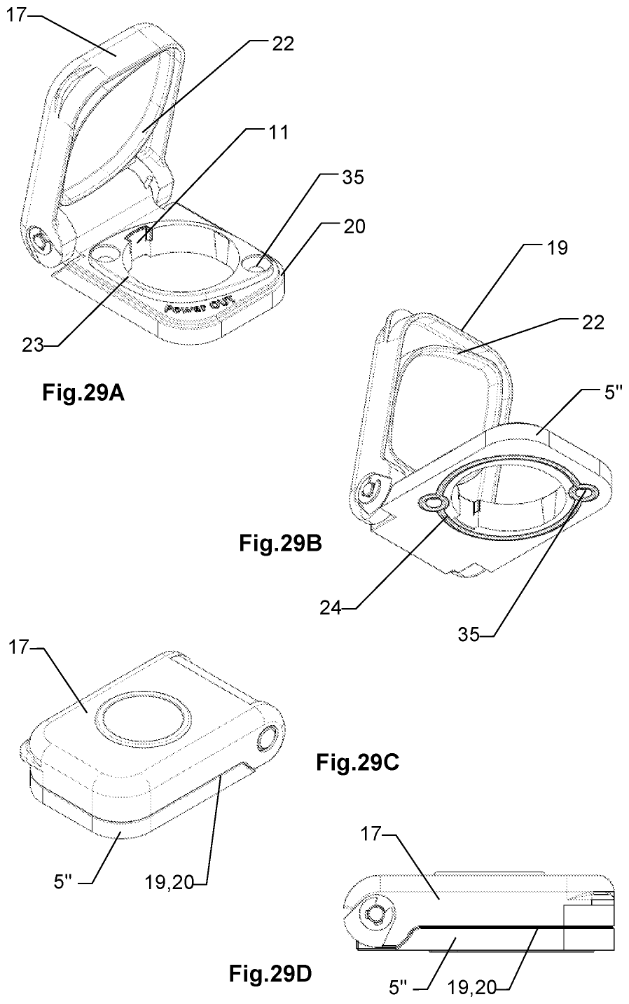

FIG. 29 shows the second-part flange 5″ used in the chassis connector according to FIGS. 11A-11D, with the cover 17 fixed to the second-part flange in a perspective view with open cover position from above (FIG. 29A) and from below (FIG. 29B), in a perspective view with closed cover position from above (FIG. 29C), and in a side view of the closed cover position (FIG. 29D).

In the view from below, for example, one can see the sealing element 24—produced, for example, by means of two-component injection molding—which is compressed when the flange is attached to the mounting plate 1. Furthermore, it can be seen that here the sealing element 24 also seals the drill holes 35 provided for mounting the flange to the mounting plate (leading into the blind holes of the first-part flange). Furthermore, the drill holes 35 are also enclosed by the sealing skirt 22 or the sealing skirt counterpart 23.

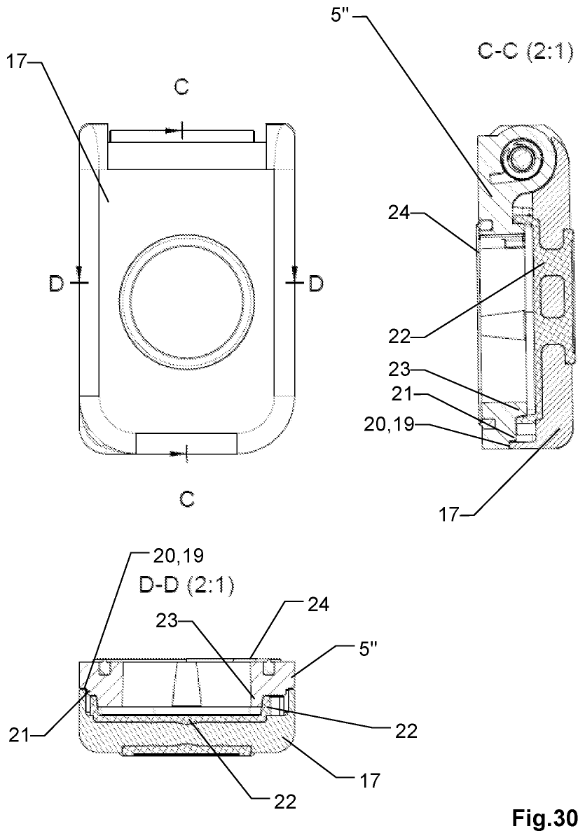

FIG. 30 shows the second-part flange 5″ with cover 17 shown in FIG. 29 in a plan view, with the cover in the closed state, and in two sections differing by ninety degrees.

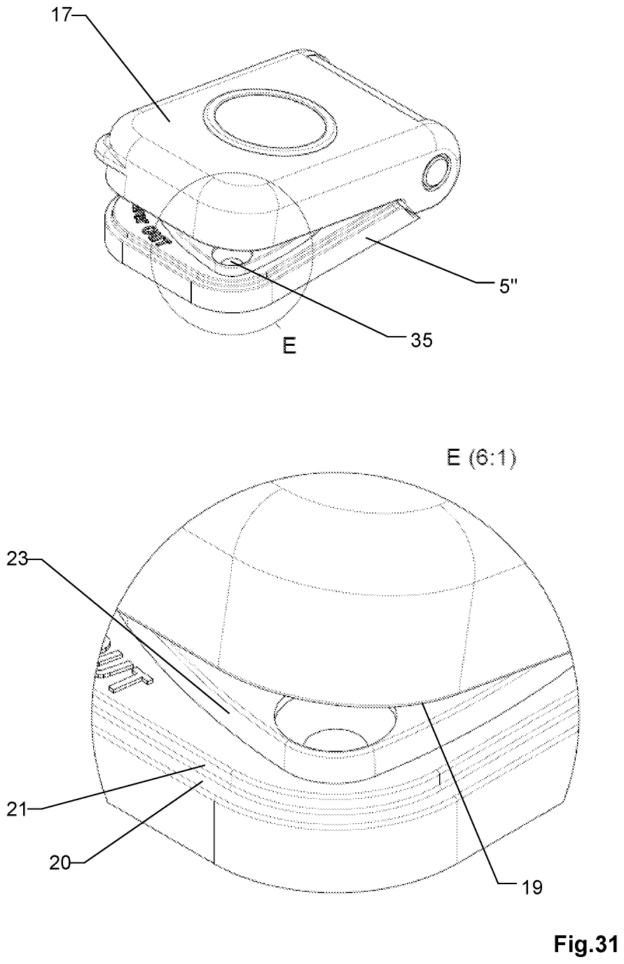

FIG. 31 shows the second-part flange 5″ with cover 17 shown in FIG. 29 in a perspective view, with the cover not fully closed and a view around one of the drill holes 35 provided for mounting on the mounting plate 1 highlighted.

In particular, the highlighted view shows that the sealing skirt counterpart 23 surrounds (i.e., co-seals) the drill hole 35. Furthermore, the view shows the cover edge bearing surface 20 and the elevation 21, which provide a labyrinth sealing effect in interaction with the cover edge 19.

It is understood that these figures shown are only schematic illustrations of possible exemplary embodiments. The various approaches can also be combined with each other and with prior art methods.

1-49. (canceled)

50. A chassis connector, for precisely mating a mechanically lockable plug connection with a cable connector matched to the chassis connector as a counterpart and insertable into an opening of the chassis connector, to enable a signal transmission, by a mating of the plug connection between the chassis connector and the cable connector, the chassis connector is adapted to be fastened to a mounting plate and to be fixedly supported by the mounting plate in the mounted state on the mounting plate, and the mounting plate has a mounting plate recess for the chassis connector and/or the cable connector, with the chassis connector being formed to be applied to and supported on a region of the mounting plate surrounding the mounting plate recess, and the mounting plate has a front side which is directed to a side from where the cable connector is adapted to be brought to the chassis connector, which is in the mounted state on the mounting plate, and an oppositely directed rear side, wherein the chassis connector comprises:
a signal transmission contact element which is provided to contact a cable-connector-side signal transmission contact element counterpart by the mating of the plug connection and to thereby provide the signal transmission across the plug connection, and
a supporting skirt region configured to provide a support effect for the cable connector with respect to loading forces acting on the cable connector perpendicular to the cable connector insertion direction in a condition generated by the insertion of the connector,
a first chassis connector part and a second chassis connector part formed in at least two parts, wherein the first and the second chassis connector parts are provided for direct fastening to the mounting plate, wherein the first chassis connector part has a first-part flange adapted to be applied to the rear side of the mounting plate and the second chassis connector part has a second-part flange adapted to be applied to the front side of the mounting plate,
the first chassis connector part comprises the signal transmission contact element, and
the second chassis connector part comprises the supporting skirt region, wherein supporting forces applied by the supporting skirt region and counteracting loading forces are adapted to be at least partially carried by the mounting plate in the mounted state of the second part by the direct fastening of the second chassis connector part to the mounting plate.

51. The chassis connector according to claim 50, wherein the first chassis connector part comprises a mechanical retaining element which is provided to block a cable-connector-side retaining element counterpart with respect to an axial movement in the cable connector extraction direction within the scope of a first part of a locking mechanism which is actuatable by rotation of the cable connector in a screwing-in direction in a state of the cable connector at least partially inserted into the chassis connector, and
the second chassis connector part comprises a mechanical locking element which is provided to cause, in the context of a second part of the locking mechanism which is actuatable by displacement of a latch slider on the cable connector side, an engagement of a latch of the cable connector connected to the latch slider into the locking element and thus to block the cable connector with respect to a rotation in an unscrewing direction which is directed opposite to the screwing-in direction.

52. The chassis connector according to claim 51, wherein the mechanical retaining element is formed as a groove assembly, wherein grooves of the groove assembly first extend axially and thus serve as key counterparts for key elements of the cable connector, and then extend normally to an axis or slightly oblique to normal to the axis and serve here as a retaining component, wherein the retaining element counterpart is formed as a lug assembly which is inserted into the groove assembly by the insertion of the plug connection and is blocked against axial withdrawal by a groove assembly region extending normally or slightly obliquely to normal to the axis, or
the mechanical retaining element is formed as a lug assembly and the retaining element counterpart is formed as a groove assembly, wherein grooves of the groove assembly, in the inserted state, first extend axially and thus serve as key elements for the lug assembly serving as key counterparts, and then extend normally to the axis or slightly obliquely to normal to the axis, and the groove assembly region extending normally or slightly obliquely to normal to the axis engages behind the lug assembly as a result of the insertion of the plug connection and the cable plug-in connector is thereby blocked against axial extraction.

53. The chassis connector according to claim 52, wherein the retaining element is arranged and provided with an oblique path such that by and upon actuation of the first part of the locking mechanism, the retaining element counterpart is moved along the oblique path until the retaining element counterpart encounters a rotational stop, which is further provided on the second chassis connector part, and thus a final insertion position of the cable connector in the chassis connector is reached.

54. The chassis connector according to claim 51, wherein the second chassis connector part has mechanical key counterparts provided to cooperate with key elements of the cable connector matched thereto such that the cable connector is insertable into the chassis connector in only one specific rotational orientation predetermined by the key counterparts.

55. A chassis connector, for precisely mating a mechanically lockable plug connection with a cable connector matched to the chassis connector as a counterpart and insertable into an opening of the chassis connector, to enable a signal transmission by a mating of the plug connection between the chassis connector and the cable connector, wherein the chassis connector is provided to be fastened to a mounting plate and to be fixedly supported by the mounting plate in a mounted state on the mounting plate, and the mounting plate has a mounting plate recess for at least one of the chassis connector or the cable connector, the chassis connector is formed to be applied to and supported on a region of the mounting plate surrounding the mounting plate recess, and the mounting plate has a front side which is directed to the side from where the cable connector is adapted to be brought to the chassis connector, which is in a mounted state on the mounting plate, and an oppositely directed rear side, wherein the chassis connector comprises:
a mechanical retaining element which is provided for blocking a cable-connector-side retaining element counterpart with respect to an axial movement in a cable connector extraction direction in the context of a first part of a locking mechanism which is actuatable by rotation of the cable connector in a screwing-in direction in a state of the cable connector being at least partially inserted into the chassis connector, and
a mechanical locking element which is provided to cause, within the scope of a second part of the locking mechanism which is actuatable by displacement of a latch slider on the cable connector side, an engagement of a latch of the cable connector connected to the latch slider into the locking element and thus to block the cable connector with respect to a rotation in the unscrewing direction which is directed opposite to the screwing-in direction,
a first chassis connector part and a second chassis connector part formed in at least two parts, wherein both the first and second chassis connector parts are provided for direct fastening to the mounting plate, wherein the first chassis connector part has a first-part flange adapted to be applied to the rear side of the mounting plate and the second chassis connector part has a second-part flange adapted to be applied to the front side of the mounting plate, and
the first part has the mechanical retaining element, and
the second part has the mechanical locking element.

56. The chassis connector according to claim 55, wherein the first chassis connector part comprises a signal transmission contact element provided to contact a cable-connector-side signal transmission contact element counterpart by mating the plug connection and thereby provide signal transmission across the plug connection.

57. The chassis connector according to claim 56, wherein the second chassis connector part comprises a supporting skirt region configured to provide a supporting action for the cable connector with respect to loading forces acting on the cable connector perpendicular to a cable connector insertion direction in a state generated by the mating of the plug connection, wherein supporting action forces applied by the supporting skirt region and counteracting loading forces are adapted to be at least partially carried by the mounting plate in a state of the second part mounted on the mounting plate by the direct fastening of the second part to the mounting plate.

58. The chassis connector according to claim 57, wherein the second chassis connector part has mechanical key counterparts which are provided to cooperate with key elements of the cable connector matched thereto such that the cable connector is insertable into the chassis connector in only one specific rotational orientation predetermined by the key counterparts.

59. The chassis connector according to claim 55, further comprising a cover for the opening, said cover is arranged in a fixed manner on the second-part flange, and the cover is openable and closable by a pivot joint and has a sealing component such that, in a closed state of the cover, the sealing component sealingly closes the opening.

60. The chassis connector according to claim 57, further comprising a sheath element of which is provided to protrude into or through the mounting plate recess in a state mounted with the first and second chassis connector parts to thereby delimit an inner region of the connector from the sheath element against the inner wall of the mounting plate recess, and has a thickness of less than 0.35 mm perpendicular to the insertion direction.

61. The chassis connector according to claim 60, wherein in the state fastened to the mounting plate, the chassis connector is free of a sheath element sheathing the cable connector at a level of the mounting plate recess, such that the chassis connector is thereby configured that a minimum mounting plate recess dimension is limited only by the cable connector.

62. The chassis connector according to claim 55, wherein the first-part flange has blind bores provided for mounting on the mounting plate, wherein each of the blind bores is provided for receiving a fastener adapted to originate from the mounting plate for fastening the first-part flange to the mounting plate.

63. The chassis connector according to claim 55, wherein at least one of the first-part flange or the second-part flange comprises a sealing element surrounding the opening, configured to create a sealing effect by pressing against the mounting plate when the chassis connector is applied to the mounting plate.

64. The chassis connector according to claim 63, wherein the sealing element is formed integrally with the first-part flange and the second-part flange, respectively.

65. A chassis connector, for precisely mating a mechanically lockable plug connection with a cable connector matched to the chassis connector as a counterpart and insertable into an opening of the chassis connector, enabling a signal transmission, by a mating of the plug connection between the chassis connector and the cable connector, wherein the chassis connector is adapted to be fastened to a mounting plate and to be fixedly supported by the mounting plate in the mounted state on the mounting plate, and the mounting plate has a mounting plate recess for the chassis connector and/or the cable connector, the chassis connector is formed to be applied to and supported on a region of the mounting plate surrounding the mounting plate recess, and the mounting plate has a front side which is directed to the side from where the cable connector can be brought to the chassis connector, which is in a mounted state on the mounting plate. and an oppositely directed rear side, wherein the chassis connector comprises:
a signal transmission contact element which is adapted to contact a cable-connector-side signal transmission contact element counterpart by the mating of the plug connection and to thereby provide a signal transmission across the plug connection, and
mechanical locking mechanism elements, which are adapted to bring about a locking cooperation of the locking mechanism elements with cable-connector-side locking mechanism counterpart elements within the scope of a locking mechanism by actuation of a cable-connector-side latch slider such that the cable connector, which is inserted in the chassis connector in a locked state, is blocked with respect to rotation and axial movement in a cable connector extraction direction,
a flange to be applied to the mounting plate and holes for fasteners for direct fastening of the chassis connector to the mounting plate,
a cover for the opening, wherein the cover is openable and closable by a pivot joint,
the opening and the holes for the fasteners, as well as any fasteners inserted therein, are sealable by a sealing assembly which enters a sealing state by closing the cover, the sealing assembly comprising a sealing skirt and a sealing skirt counterpart, and
the sealing skirt is matched in a shape and dimensions thereof to the sealing skirt counterpart such that radial tension is produced by elastic deformation of the sealing skirt over the sealing skirt counterpart over an entire circumference of the sealing skirt, and the sealing skirt and the sealing skirt counterpart each have a curved profile over the entire circumference and are convex in shape.

66. The chassis connector according to claim 65, wherein
the sealing skirt counterpart is arranged around the opening on the flange and the sealing skirt is arranged on the cover, or
the sealing skirt is arranged around the opening on the flange and the sealing skirt counterpart is arranged on the cover.

67. The chassis connector according to claim 66, wherein the locking mechanism elements comprise
a mechanical retaining element which is configured for blocking a cable-connector-side retaining element counterpart with respect to an axial movement in the cable connector extraction direction in the context of a first part of the locking mechanism which is actuatable by rotation of the cable connector in a screwing-in direction in a state of the cable connector being at least partially inserted into the chassis connector, and
a mechanical locking element which is provided to cause, in the context of a second part of the locking mechanism which is actuatable by displacement of a latch slider on the cable connector side, an engagement of a latch of the cable connector connected to the latch slider into the locking element and thus to block the cable connector with respect to a rotation in an unscrewing direction which is directed opposite to the screwing-in direction.

68. The chassis connector according to claim 65, wherein the sealing skirt counterpart or the sealing skirt encloses holes provided for mounting on the mounting plate by piercing fasteners.

69. The chassis connector according to claim 65, wherein the flange and cover are designed to match each other such that in the closed state of the cover, a labyrinth seal is formed which provides a first sealing stage with a throttling effect, and a second sealing stage downstream of the first sealing stage is provided by slipping the sealing skirt over the sealing skirt counterpart.
